(19) United States
(12) Patent Application Publication
(10) Pub. No.: US 2024/0318341 A1
(43) Pub. Date: Sep. 26, 2024

(54) PROCESS FOR THE PRODUCTION OF LITHIUM METAL OR AN ALLOY THEREOF OR FOR THE PRE-LITHIATION OF AN ELECTRODE MATERIAL

(71) Applicant: HYDRO-QUÉBEC, Montréal (CA)

(72) Inventors: François LAROUCHE, Mont-St-Hilaire (CA); Kamyab AMOUZEGAR, Mont-Royal (CA); Gabriel GIRARD, Longueuil (CA); Martin DONTIGNY, Varennes (CA); Abdelbast GUERFI, Brossard (CA); Benoit FLEUTOT, Boucherville (CA); Chisu Kim, Longueuil (CA)

(21) Appl. No.: 18/431,093

(22) Filed: Feb. 2, 2024

Related U.S. Application Data
(60) Provisional application No. 63/483,095, filed on Feb. 3, 2023.

(51) Int. Cl. C25C 1/02; C25C 7/00; C25C 7/02; H01M 6/52; H01M 10/0525; H01M 10/54

(52) U.S. Cl. CPC C25C 1/02; C25C 7/007; C25C 7/02; H01M 6/52; H01M 10/54; H01M 10/0525

(57) ABSTRACT

A relithiated Li intercalation material for producing Li metal or an alloy thereof or for pre-lithiating an electrode material as well as an anode and an electrolysis cell comprising same are provided. A method of producing Li metal or an alloy thereof or for pre-lithiating an electrode material is also provided. This method comprises carrying out a Li production electrolysis reaction in the electrolysis cell, wherein the electrolysis cell comprises the relithiated Li intercalation material as an anode, a current collector as a cathode, and an electrolyte comprising a lithium salt.

### CROSS-REFERENCE TO RELATED APPLICATIONS

This application claims benefit, under 35 U.S.C. § 119(e), of U.S. provisional application Ser. No. 63/483,095, filed on Feb. 3, 2023. All documents above are incorporated herein in their entirety by reference.

### FIELD OF THE INVENTION

The present invention relates to a process for the production of lithium metal or an alloy thereof or for pre-lithiating an electrode material. More specifically, the present invention is concerned with a process that allows, in some case, to produce lithium metal or an alloy thereof, and in other cases, to pre-lithiate an electrode material, using in both cases a relithiated Li intercalation material.

### BACKGROUND OF THE INVENTION

The production of lithium metal is traditionally carried out by the electrolysis of LiCl in a molten salt medium at very high temperatures (typically between 40° and 450° C.). The electrolyte consists of a mixture of LiCl and KCl which form a eutectic that has a melting point of 355° C. at a composition of 45% LiCl and 55% KCl. This electrolyte is chemically resistant to the chlorine gas evolved at the anode during the electrolysis and it also enables reaching current densities in the order of several thousand A/m². However, despite the high productivity of the production cells, the process suffers from several disadvantages. The electrolysis must be carried out at very high temperatures. The anodic reaction involves chlorine evolution, which is highly corrosive (especially at high temperatures). Also, the produced Li metal is in a liquid form at these high temperatures, which makes its handling more complicated due to its high reactivity in liquid form. The combination of high temperature and the handling of corrosive chlorine gas and highly reactive liquid lithium metal results in high capital and operating costs for the conventional lithium production process. Another drawback of the aforementioned conventional process for the fabrication of Li metal is that in the case of fabrication of lithium batteries based on Li metal foils as anode material, the resulting Li metal ingot must be processed into thin Li foils using several steps of extrusion and lamination, which increases investment and operating costs.

In order to decrease the electrolysis temperature and avoid the handling of liquid Li metal, it has been proposed to carry out Li electrodeposition in room temperature ionic liquid (RTIL) media. However, the proposed approach does not address the issue of having an anodic reaction that will not result in the degradation of the electrolysis medium.

The use of Li metal as anode material has been proposed with the aim of avoiding any electrolyte degradation as anodic reaction during Li metal electrodeposition. This approach has been applied both to the production of thin Li film on current collectors as well as to the pre-lithiation of anode materials (such as graphite, silicon, etc.). However, this approach that relies on Li oxidation as a compatible anodic reaction still implies the use of Li metal that has been produced using the conventional high temperature process by using LiCl as starting raw material.

Bodoin et al. (US 2022/0367874 A1) as well as Kang et al (2021/0381115 A1) have proposed the use of a Li-selective ceramic membrane in an electrolysis cell that separates the anodic compartment containing an aqueous solution of a lithium salt from the cathodic compartment containing an organic solvent with another Li salt. The process represents several advantages, namely it avoids having an anodic reaction incompatible with the electrolysis media (in this case the anodic reaction is oxygen evolution in aqueous media), the electrolysis is carried out at low temperature and the raw material for Li metal production can be any lithium salt, such as for example lithium carbonate. However, the proposed approach also has several important drawbacks such as the use of expensive and fragile ceramic membranes and the leakage of water molecules through the ceramic membrane to the organic electrolyte and the consequent contamination of lithium metal by LiOH.

On another subject, next generation energy storage technologies require advanced electrode active materials with enhanced gravimetric and volumetric capacities to achieve increased gravimetric energy and volumetric energy densities. However, most of these materials suffer from high first cycle active lithium losses, e.g., caused by solid electrolyte interphase (SEI) formation, which hindered their broad commercial use so far. Indeed, during the first charge of the cell, a certain amount of active lithium is lost so that the remaining active lithium content is reduced. In general, the loss of active lithium permanently decreases the available energy because of this consumption of lithium by the electrode material. Pre-lithiation is considered as a highly appealing technique to compensate for active lithium losses and, therefore, to increase the practical energy density. Pre-lithiation is the addition/doping of lithium to an electrode of a battery prior to battery cell operation. Pre-lithiation can effectively compensate the first cycle lithium loss and improve the initial coulombic efficiency. It is a general method can be applied to all kinds of electrode materials and improve their battery performance. Various pre-lithiation techniques have been evaluated so far, including electrochemical and chemical pre-lithiation, pre-lithiation with the help of additives or the pre-lithiation by direct contact to lithium metal.

In the case of electrochemical pre-lithiation methods, the lithium source consists of a lithium metal electrode which is paired to a lithium intercalation material. Under application of a current, the lithium metal oxidizes and migrates toward the opposite electrode where it intercalates into the lithium intercalation material. Such method is applied to the pre-lithiation of silicone intercalation material by Park et al. (WO 2019/113534 A1). In this patent application, the use of a lithium metal counter electrode pushes costs up and still involves the abovementioned issues concerning to the use of highly reactive lithium metal.

To avoid issues related to the use of metallic lithium as a lithium source for pre-lithiation, Grant et al. (U.S. Pat. No. 9,598,789 B2) developed an anode pre-lithiation method using a lithium salt dissolved in the electrolyte as lithium source, in particular LiCl. In this patent, the lithium metal counter electrode is replaced by an inert metal sheet where electrolyte degradation anodic reactions, such as chlorine evolution, are expected to take place. Such system promotes the degradation of electrolyte salt, a high power consumption, and limited current density.

### SUMMARY OF THE INVENTION

In accordance with the present invention, there is provided:
1. A relithiated Li intercalation material for producing Li metal or an alloy thereof or for pre-lithiating an electrode material.
2. Use of a relithiated Li intercalation material for producing Li metal or an alloy thereof or for pre-lithiating an electrode material.
3. The relithiated Li intercalation material/use of embodiment 1 or 2, being for producing Li metal or an alloy thereof, preferably Li metal, preferably wherein the Li metal or an alloy thereof is in the form of a film, preferably wherein the Li metal or alloy thereof is produced by electrodeposition.
4. The relithiated Li intercalation material/use of embodiment 1 or 2, being for pre-lithiating an electrode material, preferably an anode material, preferably graphite, Si, a silicon oxide (SiOx), silicon-carbon composite, carbon nanotube, or a mixture thereof.
5. The relithiated Li intercalation material/use of any one of embodiments 1 to 4, wherein the relithiated Li intercalation material is a lithium phosphate or a lithium oxide, preferably:
   Li_{w}FePO₄ (wherein w≤1.1, preferably 1),
   Li_{w}Fe₁₋ₓMnₓPO₄ (wherein w≤1.1, preferably w is 1; and 0<x≤1, preferably 0.2≤x≤0.4),
   Li_{w}Mn₂O₄ (wherein w≤1.1, preferably w is 1),
   Li_{w}Mn_{1.5}Ni_{0.5}O₄ (wherein w≤1.1, preferably w is 1),
   Li_{4+z}Ti₅O₁₂ (wherein 0≤z≤3), or
   NMC (Li_{w}Ni_{1-x-y-z}MnₓCo_{y}M_{z}O₂, wherein w≤1.3, 0≤x≤1, 0≤y≤1, and 0≤z≤1, and M is Al, Mg, Ti, Nb, Zr, W, Mo, Y, La, Ta or a mixture thereof).
6. The relithiated Li intercalation material/use of embodiment 5, wherein the relithiated Li intercalation material is Li_{w}FePO₄.
7. The relithiated Li intercalation material/use of any one of embodiments 1 to 6, wherein the relithiated Li intercalation material has been sourced from spent electrodes and then relithiated; or wherein the relithiated Li intercalation material has been used for producing Li metal or an alloy thereof or for pre-lithiating an electrode material and then relithiated.
8. The material/use according to any one of claims 1 to 7, wherein the relithiated Li intercalation material has recovered at least 50%, preferably at least 75%, more preferably at least 85%, yet more preferably at least 95%, and even more preferably at least 99% of previously deintercalated lithium ions.
9. A production anode for producing Li metal or an alloy thereof or for pre-lithiating an electrode material, the production anode comprising a relithiated Li intercalation material.
10. Use of a production anode comprising a relithiated Li intercalation material for producing Li metal or an alloy thereof or for pre-lithiating an electrode material.
11. The production anode/use of embodiment 9 or 10, wherein the relithiated Li intercalation is as defined in any one of embodiments 1 to 8.
12. The production anode/use of any one of embodiments 9 to 11, being for producing Li metal or an alloy thereof, preferably Li metal, preferably wherein the Li metal or an alloy thereof is in the form of a film, preferably wherein the Li metal or alloy thereof is produced by electrodeposition.
13. The production anode/use of embodiment 12, being for a Li production electrolysis reaction.
14. The production anode/use of embodiment 12 or 13, wherein the production anode further comprises a current collector and the relithiated Li intercalation material is deposited on the current collector.
15. The production anode/use of embodiment 14, wherein the current collector is a metal sheet, preferably made of Cu, Al, stainless steel, Ti or Ni, or is made of a conductive carbon material, or is a polymer-based current collector.
16. The production anode/use of claim 14 or 15, wherein the current collector is coated with a primer coat, such as a carbon-containing paint.
17. The production anode/use of any one of embodiments 14 to 16, wherein the current collector comprises a metal sheet made of stainless steel or Al, preferably is a carbon coated Al current collector.
18. The production anode/use of any one of embodiments 9 to 11, being for pre-lithiating an anode material, preferably graphite, Si, a silicon oxide (SiOₓ), silicon-carbon composite, carbon nanotube, or a mixture thereof.
19. The production anode/use of any one of embodiments 9 to 18, wherein the production anode is in the form of a film.
20. A production electrolysis cell for producing Li metal or an alloy thereof or for pre-lithiating an electrode material, the production electrolysis cell comprising:
   a relithiated Li intercalation material used as a production anode,
   a current collector or said electrode material used as a production cathode, and
   a production electrolyte between the production cathode and the production anode, wherein the production electrolyte comprises a production lithium salt dissolved in a production solvent.
21. Use of a production electrolysis cell for producing Li metal or an alloy thereof or for pre-lithiating an electrode material, wherein the production electrolysis cell comprises:
   a relithiated Li intercalation material used as a production anode,
   a current collector or said electrode material used as a production cathode, and
   a production electrolyte between the production cathode and the production anode, wherein the production electrolyte comprises a production lithium salt dissolved in a production solvent.
22. The production electrolysis cell/use of embodiment 20 or 21, wherein the relithiated Li intercalation material is as defined in any one of embodiments 1 to 8.
23. The production electrolysis cell/use of any one of embodiments 20 to 22, wherein the production anode is as defined in any one of embodiments 9 to 20.
24. The production electrolysis cell/use of any one of embodiments 20 to 23, being for producing Li metal or an alloy thereof, preferably Li metal, preferably wherein the Li metal or the alloy thereof is in the form of a film, preferably wherein the Li metal or the alloy thereof is produced by electrodeposition, and wherein the current collector is used as the production cathode.
25. The production electrolysis cell/use of embodiment 24, wherein the current collector used as the production cathode is in the form of a foil.
26. The production electrolysis cell/use of embodiment 24 or 25, wherein operating conditions, such as agitation and/or temperature control, are used to modify the morphology of the produced Li metal or alloy thereof.
27. The production electrolysis cell/use of any one of embodiments 24 to 26, wherein the current collector used as the production cathode is made of Cu, Al, protected Al, C, stainless steel, Ti, Zn, or Ni, or any alloy thereof, or is a polymer-based metallized current collector, or a combination thereof.
28. The production electrolysis cell/use of any one of embodiments 24 to 27, wherein the current collector used as the production cathode is made of Cu or protected Al.
29. The production electrolysis cell/use of any one of embodiments 24 to 28, wherein the current collector used as the production cathode is protected by a protection layer.
30. The production electrolysis cell/use of any one of embodiments 24 to 28, wherein the current collector used as the production cathode is unprotected.
31. The production electrolysis cell/use of any one of embodiments 24 to 30, wherein the surface of the current collector used as the production cathode is treated or modified to improve its lithiophilicity.
32. The production electrolysis cell/use of any one of embodiments 24 to 31, wherein the surface of the current collector used as the production cathode is treated or modified to have a 3D structure to improve the electrochemical performance of the Li layer in batteries or to increase its reaction rate e.g., when used for the fabrication of an organolithium compound.
33. The production electrolysis cell/use of any one of embodiments 24 to 32, being for producing said alloy; the alloy preferably comprising about 80 w/w % or more of Li, more preferably about 85 w/w % or more of Li, even more preferably about 90 w/w % or more of Li, yet more preferably about 95 w/w % or more of Li, based on the total weight of the alloy.
34. The production electrolysis cell/use of embodiment 33, wherein the production electrolyte further comprises an alloying salt, preferably wherein the alloying salt is a salt of one or more of Na, K, Mg, Ca, a transition metal, Al, Ga, or Sn, and more preferably a salt of Al or Mg.
35. The production electrolysis cell/use of embodiment 34, wherein the alloying salt is a (flurosulfonyl)(trifluoromethanesulfonyl)imide salt, a 2-trifluoromethyl-4,5-dicyanoimidazolate (TDI) salt, a 4,5-dicyano-1,2,3-triazolate (DCTA) salt, a bis(pentafluoroethylsulfonyl)imide (BETI) salt, a difluorophosphate (DFP) salt, a chloride salt, a bromide salt, a fluoride salt, a hexafluoroarsenate (AsF₆) salt, a fluoroalkylphosphate salt, a tetrakis(trifluoroacetoxy)borate salt, a bis(1,2-benzenediolato (2-)-O,O′)borate salt, a difluoro(oxalato)borate salt, a nitrate salt, a trifluoroacetate salt, a hexafluorophosphate salt, a tetrafluoroborate salt, a bis(oxalate)borate (BOB) salt, a perchlorate salt, a bis(trifluoromethanesulfonyl)imide (TFSI), a bis(fluorosulfonyl)imide (FSI) salt, a triflate salt, or a salt with an anion of formula: BF₂O₄Rₓ⁻(Rₓ═C₂₋₄alkyl).
36. The production electrolysis cell/use of any one of embodiments 24 to 32 wherein the production electrolyte is free of an alloying salt, and the production electrolysis cell/use is for producing Li metal.
37. The production electrolysis cell/use of any one of embodiments 20 to 23, being for pre-lithiating an electrode material, preferably an anode material, preferably graphite, Si, a silicon oxide, or a mixture thereof, and wherein the electrode material is used as the production cathode.
38. The production electrolysis cell/use of any one of embodiments 20 to 37, wherein the production lithium salt is lithium (flurosulfonyl)(trifluoromethanesulfonyl)imide, lithium 2-trifluoromethyl-4,5-dicyanoimidazolate (LiTDI), lithium 4,5-dicyano-1,2,3-triazolate (LiDCTA), lithium bis(pentafluoroethylsulfonyl)imide (LiBETI), lithium difluorophosphate (LiDFP), lithium chloride (LiCl), lithium bromide (LiBr), lithium hexafluoroarsenate (LiAsF₆⁻, a lithium fluoroalkylphosphate [such as LiPF₃(CF₂CF₃)₃], lithium tetrakis(trifluoroacetoxy)borate (LiB(OCOCF₃)₄), lithium bis(1,2-benzenediolato (2-)-O,O′)borate LiB(C₆O₂)₂, lithium difluoro(oxalato)borate (LiBF₂(C₂O₄)), a compound of formula BF₂O₄Rₓ⁻(Rₓ═C₂₋₄alkyl), LiCF₃COO, LiF, LiNO₃, LiPF₆, LiBF₄, LiBOB, LiClO₄, LiTFSi, CF₃SO₃Li, LiFSi, or any combination thereof, preferably LiCF₃COO, LiF, LiNO₃, LiPFs, LiBF₄, LiBOB, LiClO₄, LiTFSi, CF₃SO₃Li, LiFSi, or any combination thereof.
39. The production electrolysis cell/use of embodiment 38, wherein the production lithium salt is a combination of CF₃SO₃Li and LiFSi.
40. The production electrolysis cell/use of any one of embodiments 20 to 39, wherein the production electrolyte further comprises one or more additives, preferably one or more additives that modify the morphology and/or properties of the Li metal or alloy, one or more additives that influence the phase nucleation energy, one or more additives that influence the Li or alloy deposition potential, and/or one or more additives that influence the Li electrodeposition efficiency; more preferably the one or more additives is/are:
   an unsaturated cyclic carbonate such as vinylene carbonate (VC),
   a halogenated cyclic carbonate such as fluoroethylene carbonate (FEC),
   a nitrate,
   a Li polymerisation agent that comprises a saturated or unsaturated hydrocarbon chain, such as 1,8-diazabicyclo[5.4.0]undec-7-ene (DBU),
   a Li passivating compound, and/or
   an alkaline salt of an organic acid, such as lithium difluoro(oxalate)borate (LiDFOB) or Li oxalate.
41. The production electrolysis cell/use of any one of embodiments 20 to 40, wherein the production solvent is an organic carbonate, an organic ester, an organic ether, an ionic liquid, or any combination thereof.
42. The production electrolysis cell/use of embodiment 41, wherein the production solvent is ethylene carbonate (EC), propylene carbonate (PC), fluoroethylene carbonate (FEC), gamma-butyrolactone (gBL), ethyl propionate, diethyl carbonate (DEC), dimethyl carbonate (DMC), ethyl methyl carbonate (EMC), dimethoxyethane (DME), fluoroether, tetrafluoroethyl tetrafluoropropyl ether (TTE), tetraethylene glycol dimethyl ether (TEGDME) or any combination thereof.
43. The production electrolysis cell/use of embodiment 42, wherein the production solvent is a combination of EC and DEC.
44. The production electrolysis cell/use of any one of embodiments 20 to 43, wherein the production electrolysis cell is free of a membrane separating the production anode from the production cathode.
45. The production electrolysis cell/use of embodiment 44, wherein the production electrolysis cell is in a roll-to-roll configuration.
46. The production electrolysis cell/use of embodiment 44 or 45, wherein the production electrolysis cell further comprises one or more calendering devices, such as pairs of calendering rolls, e.g., at fixed intervals.
47. A method for producing Li metal or an alloy thereof or for pre-lithiating an electrode material, the method comprising:
   a) providing a relithiated Li intercalation material, and
   b) carrying out a Li production electrolysis reaction in a production electrolysis cell,
   wherein the production electrolysis cell comprises:
      said relithiated Li intercalation material as a production anode,
      a current collector or said electrode material as a production cathode, and
      a production electrolyte between the production cathode and the production anode, wherein the production electrolyte comprises a production lithium salt dissolved in a production solvent,
   thereby electrodepositing Li metal or the alloy thereof on the current collector used as the production cathode or introducing lithium in said electrode material used as the production cathode thus producing a pre-lithiated electrode, and
   thereby producing a partially or completely de-lithiated Li intercalation material.
48. The method of embodiment 47, wherein the relithiated Li intercalation material is as defined in any one of embodiments 1 to 8.
49. The method of embodiment 47 or 48, wherein the production anode is as defined in any one of embodiments 9 to 19.
50. The method of any one of embodiments 47 to 49, wherein the production electrolysis cell is as defined in any one of embodiments 20 to 46.
51. The method of any one of embodiments 47 to 50, wherein the Li production electrolysis reaction is carried out by controlling cell potential either between the production anode and the production cathode, or between the production cathode and a reference electrode.
52. The method of any one of embodiments 47 to 50, wherein the Li production electrolysis reaction is carried out by controlling cell current.
53. The method of embodiment 52, wherein the Li production electrolysis reaction in controlled current mode is carried out in direct mode, in a pulsating mode, either continuous or reverse.
54. The method of embodiment 52 or 53, wherein the Li production electrolysis reaction in controlled current mode is carried out at a fixed frequency or under a varying frequency.
55. The method of any one of embodiments 47 to 54, wherein step a) is carried out in a roll-to-roll configuration.
56. The method of any one of embodiments 47 to 55, wherein step b) is carried out in a roll-to-roll configuration.
57. The method of any one of embodiments 47 to 56, wherein the partially or completely de-lithiated Li intercalation material is a partially or completely de-lithiated lithium phosphate or lithium oxide, preferably partially or completely de-lithiated Li_{w}FePO₄, Li_{w}Mn₂O₄, Li_{4+z}Ti₅O₁₂, or NMC (Li_{w}Ni_{1-x-y}MnₓCo_{y}M_{z}O₂).
58. The method of embodiment 57, wherein the partially or completely de-lithiated Li intercalation material is partially or completely de-lithiated Li_{w}FePO₄.
59. The method of any one of embodiments 47 to 58, wherein the relithiated Li intercalation material is washed, preferably washed and dried, before being used in step b).
60. The method of any one of embodiments 47 to 59, wherein step a) comprises:
   a′) providing a partially or completely de-lithiated Li intercalation material and
   a″) relithiating the partially or completely de-lithiated Li intercalation material,
   thereby producing a relithiated Li intercalation material.
61. The method of embodiment 60, further comprising step c) of repeating step a) and step b) one or more times, using in steps a′) and a″) the partially or completely de-lithiated Li intercalation material produced in step b.
62. The method of embodiment 60 or 61, wherein the partially or completely de-lithiated Li intercalation material provided at step a′) is the partially or completely de-lithiated Li intercalation material produced at step b).
63. The method of any one of embodiments 47 to 60, wherein the partially or completely de-lithiated Li intercalation material is obtained from recycled spent batteries.
64. The method of any one of embodiments 47 to 63, wherein step a″) comprises carrying out a relithiation electrolysis reaction in a relithiation electrolysis cell, wherein the relithiation electrolysis cell comprises:
   the partially or completely de-lithiated intercalation material as a relithiation cathode,
   a relithiation anode, and
   a relithiation electrolyte between the relithiation cathode and the relithiation anode,
   wherein the relithiation electrolyte comprises a relithiation lithium salt dissolved in a relithiation solvent,
thereby relithiating the partially or completely de-lithiated intercalation material and producing the relithiated Li intercalation material.
65. The method of embodiment 64, wherein the relithiation solvent is water.
66. The method of embodiment 64 or 65, wherein the relithiation anode is made of a material compatible with an anodic reaction occurring at the relithiation anode, preferably compatible with an oxygen evolution reaction.
67. The method of any one of embodiments 64 to 66, wherein the relithiation anode is made of lead, platinum, titanium, another inert metal, or an alloy thereof, or graphite.
68. The method of any one of embodiments 64 to 66, wherein the relithiation anode is a dimensionally stable anode.
69. The method of any one of embodiments 64 to 68, wherein the relithiation electrolyte further comprises one or more additives; preferably one or more additives that improve the electric conductivity properties of the relithiation electrolyte; more preferably a salt comprising an alkali metal cation other than Li or an alkaline earth metal cation (preferably potassium or magnesium) and an anion compatible with the relithiation electrolysis reaction (preferably sulfate or bicarbonate).
70. The method of any one of embodiments 64 to 69, wherein the relithiation salt is Li₂CO₃, LiHCO₃, LiOH, LiNO₃, LiOH, Li₂SO₄, LiCH₃COO, LiFSI, LiTFSI, or Li₂C₂O₄, or a mixture thereof, preferably the relithiation salt is LiHCO₃, Li₂SO₄, or a mixture thereof, most preferably the relithiation salt is Li₂SO₄.
71. The method of any one of embodiments 64 to 70, wherein the relithiation salt is a low-cost lithium salt.
72. The method of any one of embodiments 64 to 71, wherein the relithiation solvent is water, and the relithiation salt is a water-soluble relithiation salt.
73. The method of any one of embodiments 64 to 72, wherein the relithiation salt is a water-soluble relithiation salt that has a water solubility higher than the water solubility of LiHCO₃.
74. The method of embodiment 73, wherein the water-soluble relithiation salt that has a water solubility higher than the water solubility of LiHCO₃ is LiNO₃, Li₂SO₄, or LiCH₃COO.
75. The method of any one of embodiments 64 to 74, further comprising the step of producing the relithiation salt in the relithiation electrolysis cell.
76. The method of embodiment 75, comprising adding a lithium precursor and a reactant to the relithiation electrolysis cell and allowing the lithium precursor and the reactant to react to form the relithiation salt.
77. The method of embodiment 76, wherein the lithium precursor and the reactant are added to a salt formation compartment of the relithiation electrolysis cell that is in fluid communication with a main compartment of the relithiation electrolysis cell; the main compartment comprising the relithiation cathode and the relithiation anode.
78. The method of any one of embodiments 64 to 74, wherein the relithiation salt is prepared before being added to the relithiation electrolysis cell.
79. The method of embodiment 78, further comprising reacting a lithium precursor and a reactant in a separate reactor to obtain the relithiation salt and then adding the relithiation salt to the relithiation electrolysis cell.
80. The method of any one of embodiment 76, 77, and 79, wherein the lithium precursor is Li₂CO₃, LiOH, or a mixture thereof, preferably Li₂CO₃.
81. The method of any one of embodiment 76, 77, and 79-80, wherein the reactant is CO₂, H₂SO₄, nitric acid, acetic acid, oxalic acid, or an acid form of a sulfonyl-imide salt, or a mixture thereof, preferably CO₂ or H₂SO₄ or a mixture thereof.
82. The method of embodiment 81, wherein the reactant is CO₂.
83. The method of embodiment 81, wherein the reactant is H₂SO₄.
84. The method of any one of embodiments 64 to 83, wherein the relithiation electrolysis reaction is carried out by controlling cell potential either between the relithiation anode and the relithiation cathode, or between the relithiation cathode and a reference electrode.
85. The method of any one of embodiments 64 to 83, wherein the relithiation electrolysis reaction is carried out by controlling cell current.
86. The method of embodiment 85, wherein the relithiation electrolysis reaction in controlled current mode can be carried out in direct mode, in a pulsating mode, either continuous or reverse.
87. The method of embodiment 85 or 86, wherein the relithiation electrolysis reaction in controlled current mode can be carried out at a fixed frequency or under a varying frequency.
88. The method of any one of embodiments 47 to 87, wherein step a″) comprises (i) adding the partially or completely de-lithiated intercalation material to a solution containing a reducing agent and a relithiation salt in a solvent; thereby relithiating the partially or completely de-lithiated intercalation material and producing the relithiated Li intercalation material.
89. The method of embodiment 88, further comprising (ii) separating the relithiated Li intercalation material from the solution; and (iii) electrochemically treating the solution separated in step (ii) to regenerate the reducing agent.
90. The method of embodiment 88 or 89, wherein the relithiation salt is as defined in any one of embodiments 70 to 74.
91. The method of any one of embodiments 88 to 90, wherein the reducing agent is a reducing member of a redox couple exhibiting a lower redox potential than the redox potential of the partially or completely de-lithiated intercalation material.
92. The method of embodiment 91, wherein the redox couple comprises an Fe(Ill)/Fe(II) complex
93. The method of embodiment 92, wherein the redox couple is [Fe(CN)₆]³⁻/Fe(CN)₆]⁴⁻, [Fe(nta)]/[Fe(nta)]⁻, [Fe(tdpa)]²⁻/Fe(tdpa)]³⁻, [Fe(edta)]/[Fe(edta)]²⁻, [Fe(citrate)]/[Fe(citrate)]⁻, [Fe(III)-TEA]/[Fe(II)-TEA], or [Fe(oxalate)]*/[Fe(oxalate)].
94. The method of any one of embodiments 87 to 93, wherein step (i) further comprises deoxygenating the solution.
95. The method of any one of embodiments 87 to 94, wherein steps (i) and/or (iii) are carried out in the absence of oxygen.
96. The method of any one of embodiments 87 to 95, further comprising adjusting the pH of the solution.
97. The method of any one of embodiments 87 to 96, wherein the solvent is an aqueous solvent.
98. The method of any one of embodiments 87 to 97, wherein step (iii) is carried out in an electrolytic cell by passing a current between at least one cathode and at least one anode.
99. The method of embodiment 98, wherein the electrolytic cell includes at least one ionic or non-ionic separator installed between the anode and the cathode in order to protect the regenerated reducing agent.
100. The method of embodiment 98 or 99, wherein the electrolytic cell further includes a system for keeping the solution deoxygenated.
101. The method of any one of embodiment 98 to 100, wherein step (iii) is carried out by controlling cell potential either between the anode and the cathode, or between the cathode and a reference electrode.
102. The method of any one of embodiment 98 to 101, wherein step (iii) is carried out by controlling cell current.
103. The method of embodiment 102, wherein the relithiation reaction in controlled current mode is carried out in direct mode, in a pulsating mode, either continuous or reverse.
104. The method of embodiment 102 or 103, wherein the relithiation reaction in controlled current mode is carried out at a fixed frequency or under a varying frequency.
105. The method of any one of embodiments 47 to 104, further comprising washing and drying the current collector with the electrodeposited Li metal or alloy thereof or the pre-lithiated electrode produced at step b).
106. The method of any one of embodiments 47 to 105, further comprising using the current collector with the Li metal or the alloy thereof or the pre-lithiated electrode as a negative electrode in a primary or secondary Li battery, preferably a lithium-ion battery, as a source of Li metal or an alloy for the prelithiation of electrode material, or an all-solid-state battery, or as a source of lithium for the manufacture of an energy storage system.
107. The method of any one of embodiments 47 to 106, further comprising laminating the current collector with the Li metal or the alloy thereof to modify a morphology, density or thickness of a film of the Li metal or the alloy thereof.
108. The method of any one of embodiments 47 to 107, further comprising treating the current collector with the Li metal or the alloy thereof to create a 3D structure.
109. The method of any one of embodiments 47 to 108, further comprising treating the current collector with the Li metal or the alloy thereof to improve electrochemical performance in batteries.
110. The method of any one of embodiments 47 to 105, further comprising using the current collector with the Li metal or the alloy thereof as a source of Li metal or an alloy thereof for the preparation of an organolithium compound.
111. The method of embodiment 110, wherein the Li metal or the alloy thereof is reacted with a reagent, such as an alkyl halide, to produce the organolithium compound.
112. The method of embodiment 111, further comprising transferring the current collector with the Li metal or the alloy thereof produced at step b) to a separate reactor, preferably in roll-to-roll mode, and reacting the Li metal or the alloy thereof with said reagent in said separate reactor to produce the organolithium compound.
113. The method of any one of embodiments 47 to 112, being for pre-lithiating an electrode material, preferably an anode material, preferably graphite, Si, a silicon oxide (SiOₓ), silicon-carbon composite, carbon nanotube, or a mixture thereof, and wherein the electrode material is used as the production cathode.
114. The method of any one of embodiments 47 to 112, being for producing Li metal or an alloy thereof, preferably Li metal, preferably wherein the Li metal or alloy thereof is produced by electrodeposition, and wherein the current collector is used as the production cathode.
115. The method of embodiment 114, wherein the Li metal or the alloy thereof is electrodeposited on the current collector in the form of a film, preferably of high purity.
116. A lithium electrode comprising the current collector with the Li metal or the alloy thereof produced by the method of any one of embodiments 47 to 115.
117. A lithium battery comprising the lithium electrode of embodiment 116; preferably wherein the lithium battery is a lithium-ion battery or an all-solid-state battery.

### BRIEF DESCRIPTION OF DRAWINGS

### In the Appended Drawings:

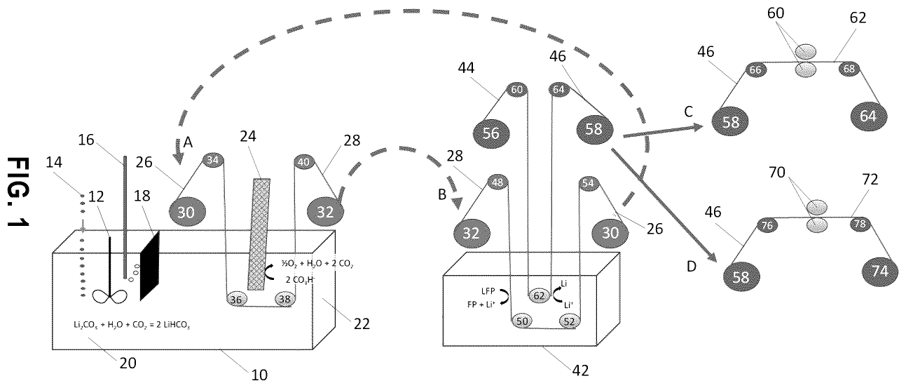

FIG. 1 is a scheme of an embodiment of the process of the invention using LiHCO₃ as the relithiation salt.

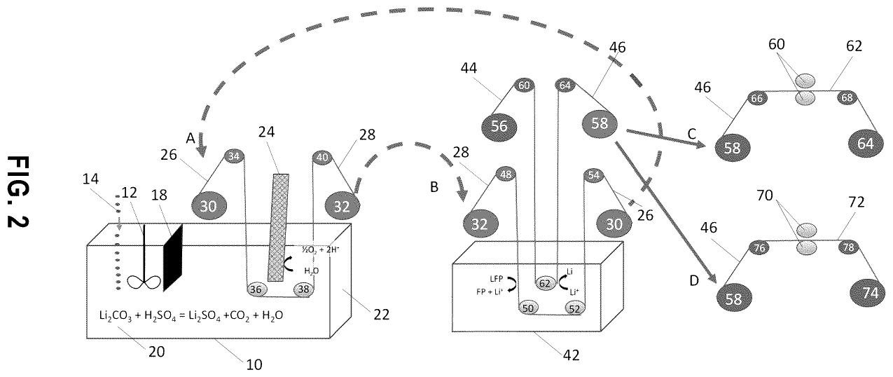

FIG. 2 is a scheme of an embodiment of the process of the invention using Li₂SO₄ as the relithiation salt.

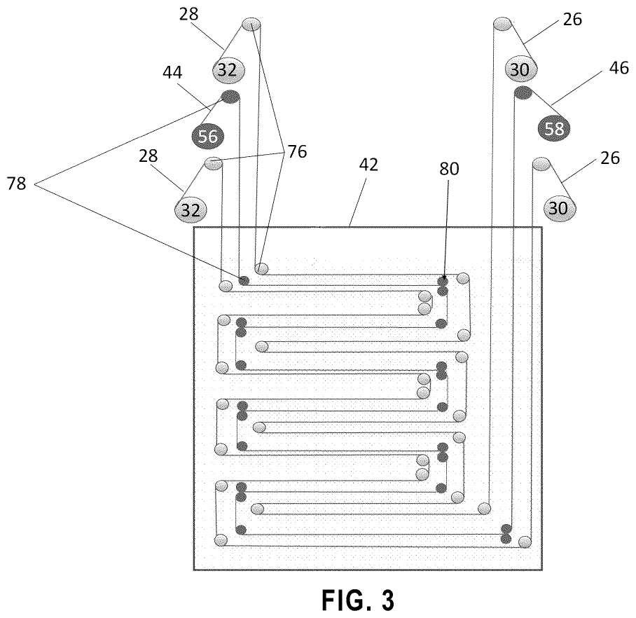

FIG. 3 shows a production electrolysis cell with multi-layered electrolysis configuration.

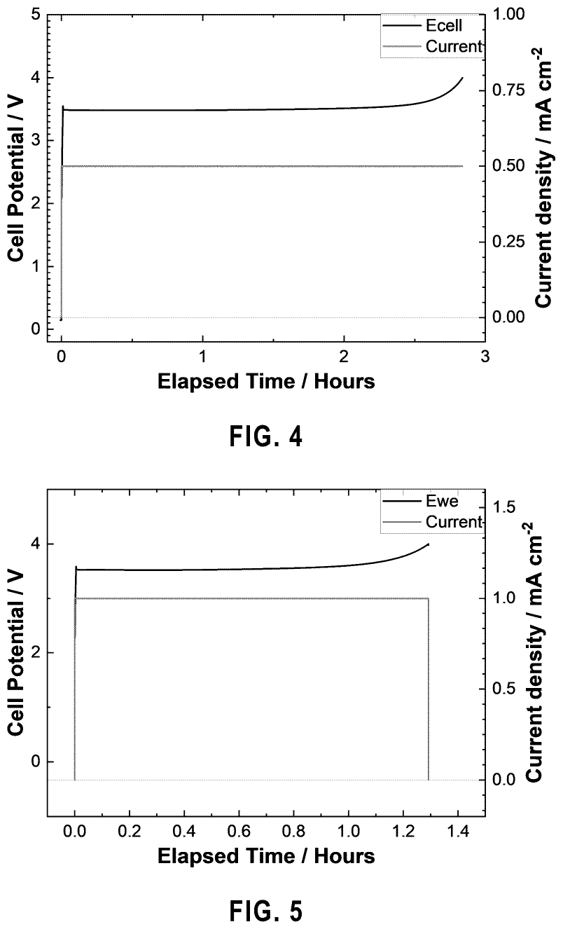

FIG. 4 shows the cell potential response with time (top black line) of galvanostatic electrodeposition of metallic lithium in Example 4. The gray bottom line represents the applied current density.

FIG. 5 shows the cell potential response with time (top black line) of galvanostatic electrodeposition of metallic lithium in the coin cell of Example 5. The gray bottom line represents the applied current density.

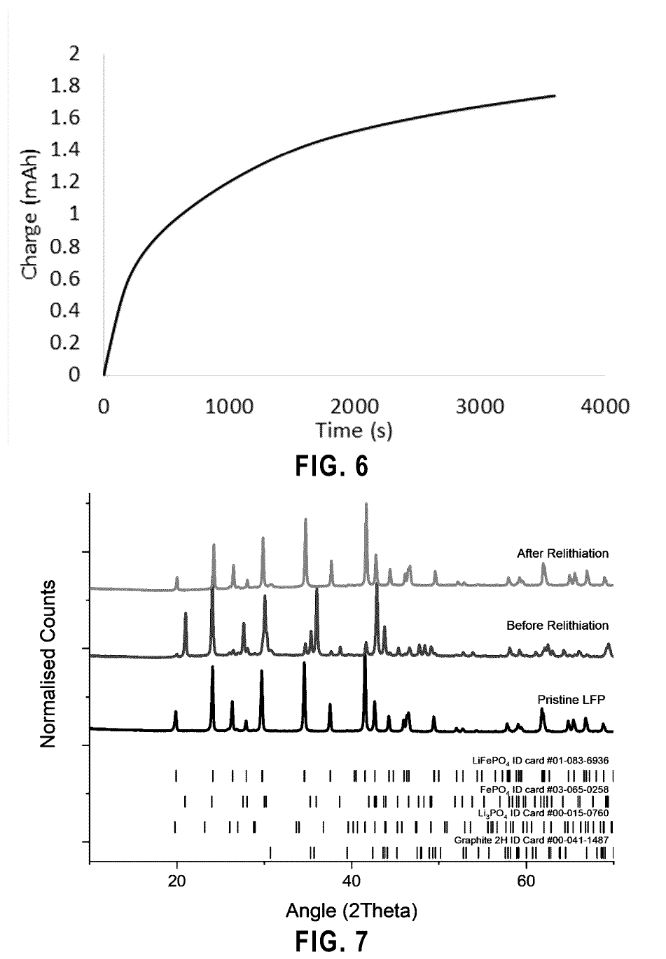

FIG. 6 shows the chrono-coulometry of relithiation process of de-lithiated LiFePO₄ (FP) to LiFePO₄ (LFP). Note that de-lithiated LiFePO₄ is also sometimes referred to herein as FePO₄ (despite the fact that it can contain remaining lithium) or FP.

FIG. 7 shows the comparison of X-ray diffraction (XRD) spectra of a pristine LFP, a FP electrode before relithiation and a LFP electrode after relithiation.

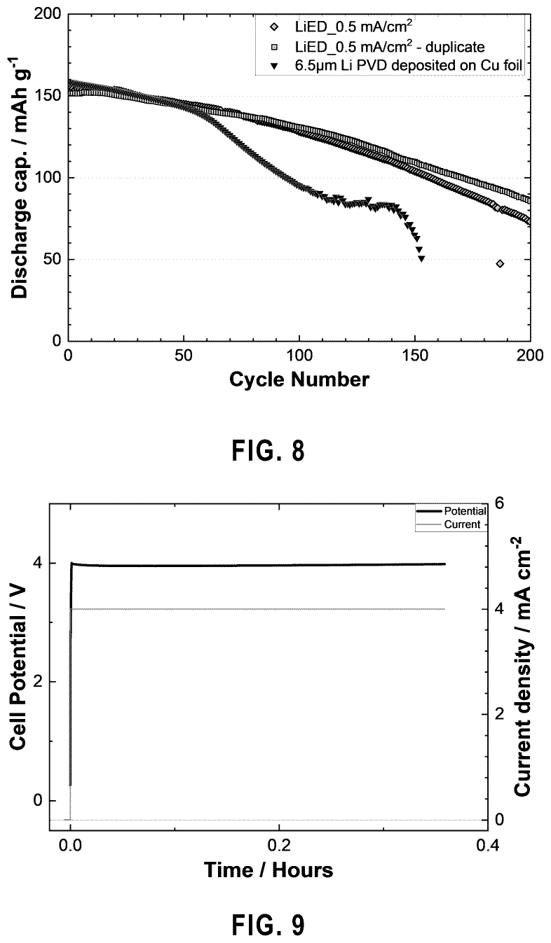

FIG. 8 shows the comparison of the cycling stability between cells with commercially available Li PVD (physical vapor deposition) as anode (triangles) and duplicate cells with an electrodeposited lithium (LiED) as anode (obtained from Example 4) (squares and lozenges).

FIG. 9 shows the potential response with time (top black line) of galvanostatic electrodeposition of metallic lithium. The gray line represents the applied current density.

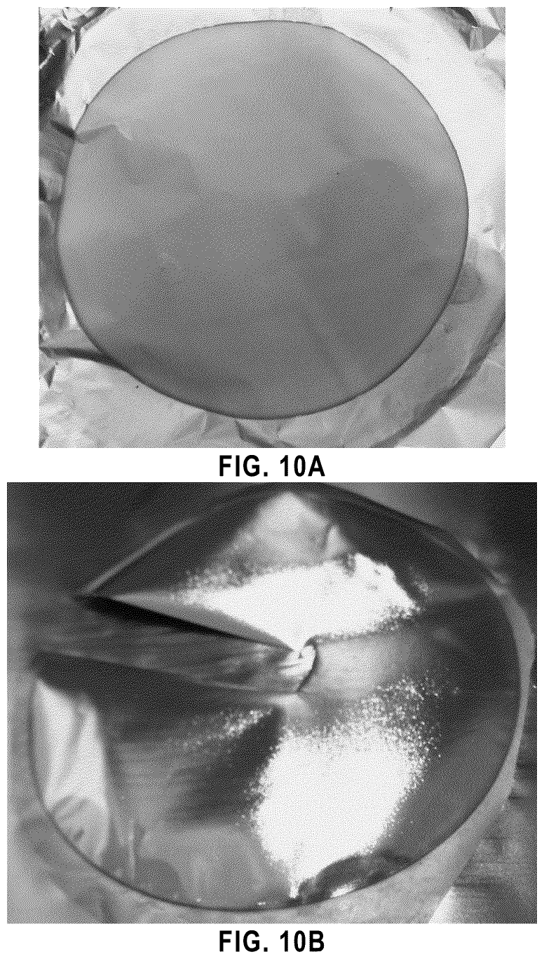

FIG. 10A shows the aspect of electrodeposited lithium from Example 7 before calendering.

FIG. 10B shows the aspect of electrodeposited lithium from Example 7 after calendering.

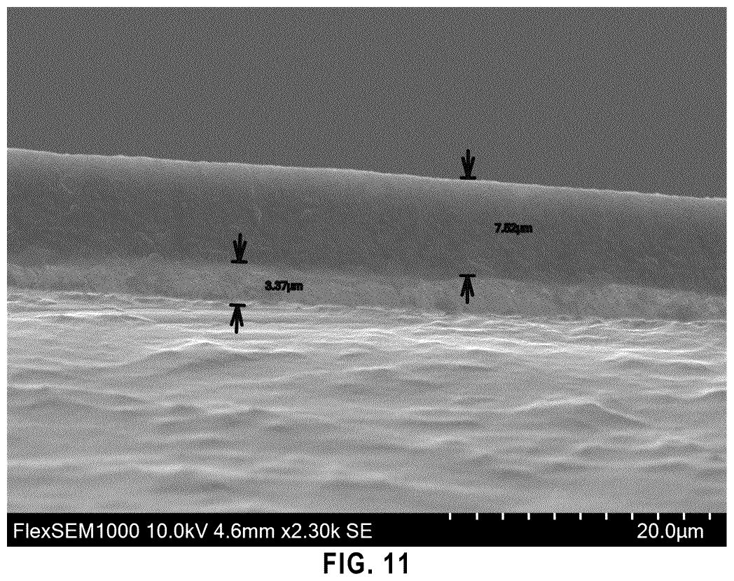

FIG. 11 shows is a scanning electron microscopy (SEM) micrograph of a cross-section of calendered electrodeposited lithium from Example 7. The thicker top layer, corresponding to the electrodeposited layer, is 7.52 ρ thick while the thinner bottom layer, corresponding to the Cu foil, is 3.37 μm thick.

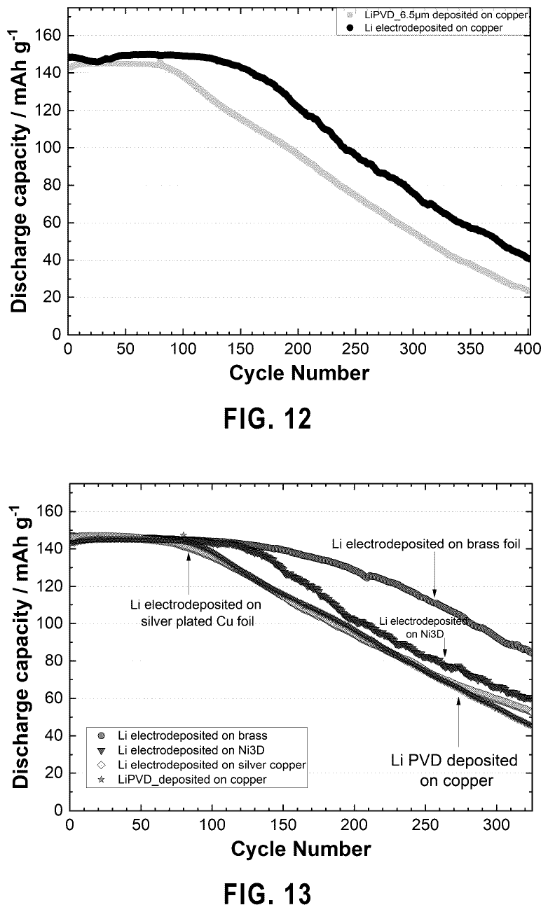

FIG. 12 compares the cycling stability of the electrodeposited Li from Example 7 and a Li foil prepared by PVD.

FIG. 13 compares the cycling stability of the Li electrodeposited on various current collectors.

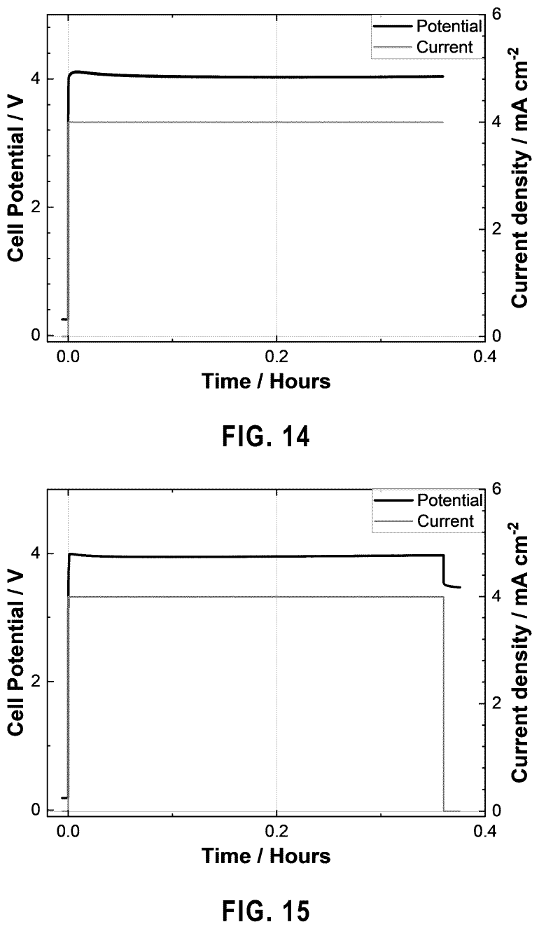

FIG. 14 shows the cell potential response with time (top black line) of galvanostatic electrodeposition of metallic lithium in Example 8.1. The gray bottom line represents the applied current density.

FIG. 15 shows the cell potential response with time (top black line) of galvanostatic electrodeposition of metallic lithium in Example 8.2. The gray bottom line represents the applied current density.

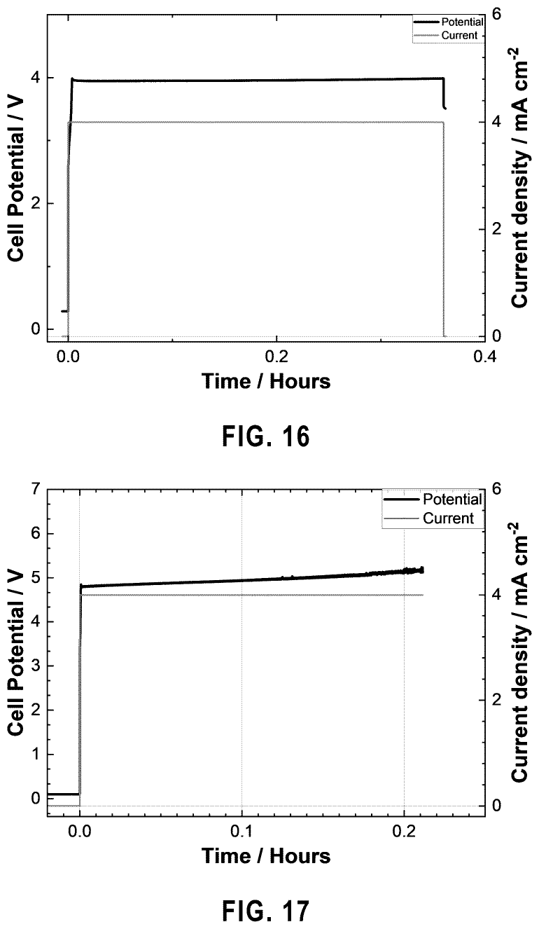

FIG. 16 shows the cell potential response with time (top black line) of galvanostatic electrodeposition of metallic lithium in Example 8.3. The gray bottom line represents the applied current density.

FIG. 17 shows the cell potential response with time (top black line) of galvanostatic electrodeposition of metallic lithium in Example 9. The gray bottom line represents the applied current density.

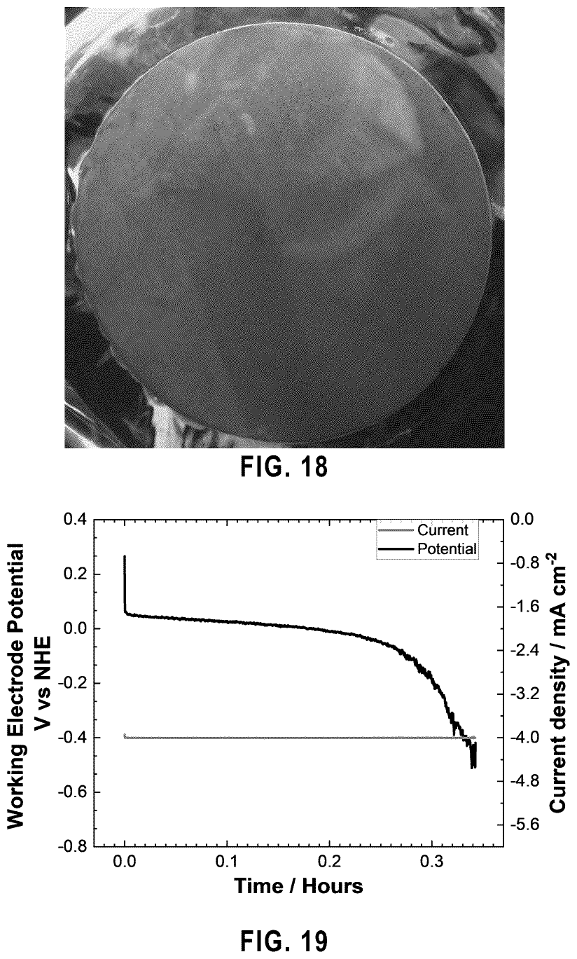

FIG. 18 shows the aspect of electrodeposited lithium from Example 9.

FIG. 19 shows the cell potential response with time (top black line) of galvanostatic electrochemical relithiation of de-lithiated LFP to LFP in Example 10. The gray bottom line represents the applied current density.

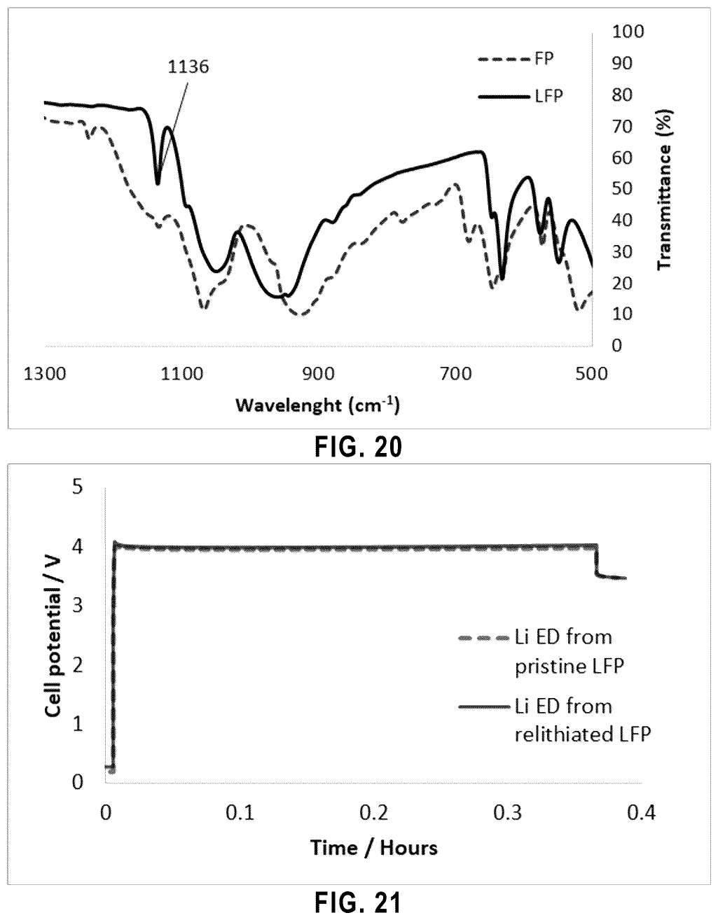

FIG. 20 shows the FTIR spectra of the electrode of Example 10 de-lithiated (FP) and relithiated (LFP).

FIG. 21 shows the cell potential response with time of electrodeposited lithium (Li ED) from Example 10 (Li ED from relithiated LFP, full line) and Example 8.2 (Li ED from pristine LFP, dashed line).

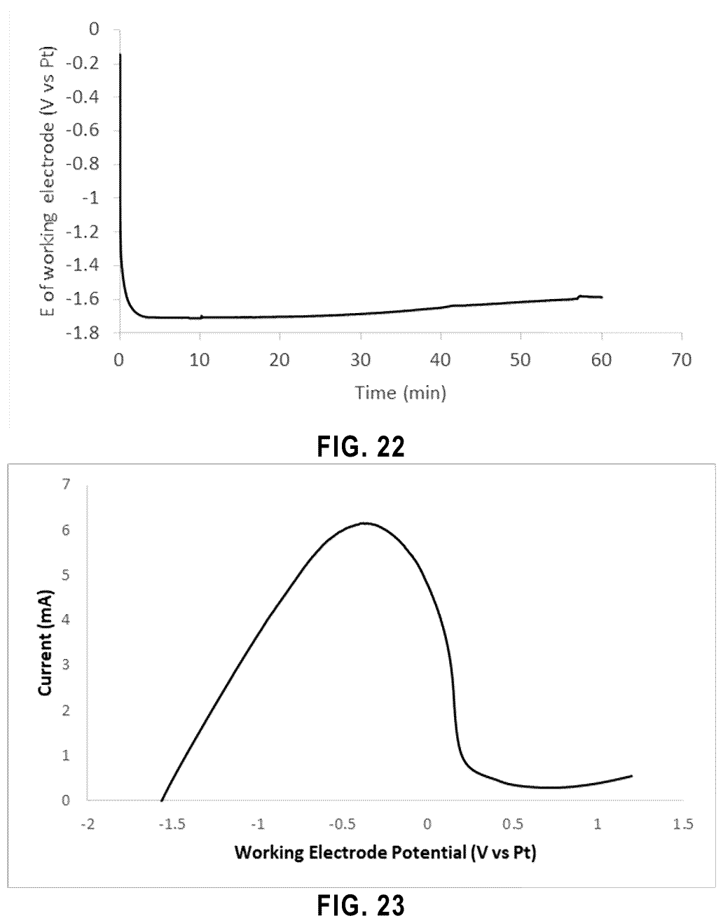

FIG. 22 shows the evolution of the LTO working electrode potential during the relithiation of Example 11.

FIG. 23 shows the anodic linear scan voltammogram of the relithiated LTO electrode of Example 11.

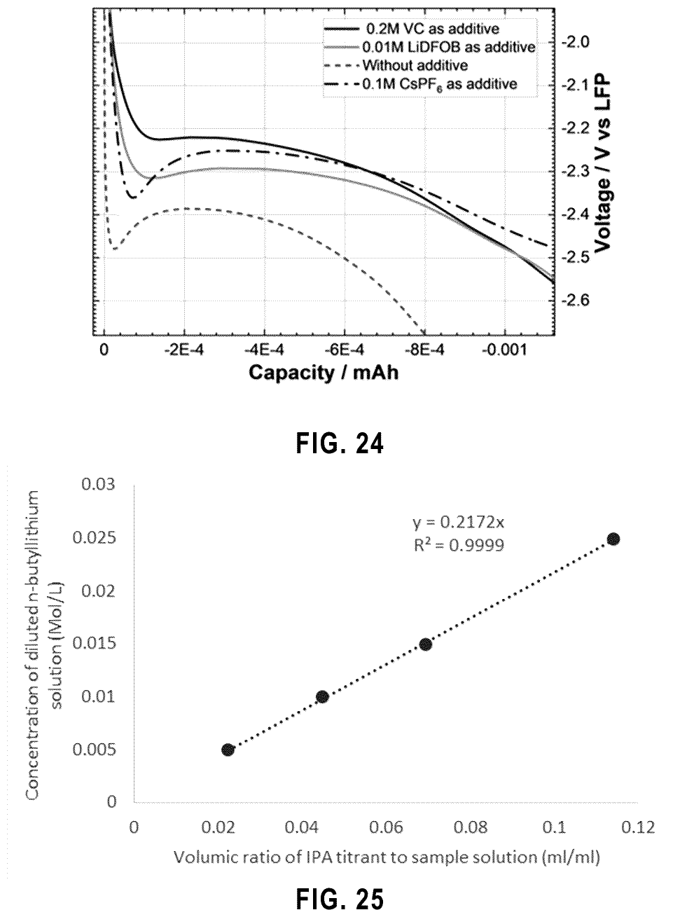

FIG. 24 compares the effect of various additives added to the electrolyte during electrodeposition of Li.

FIG. 25 shows the titration curve developed to determine the concentration of n-butyllithium in n-hexane (Example 13).

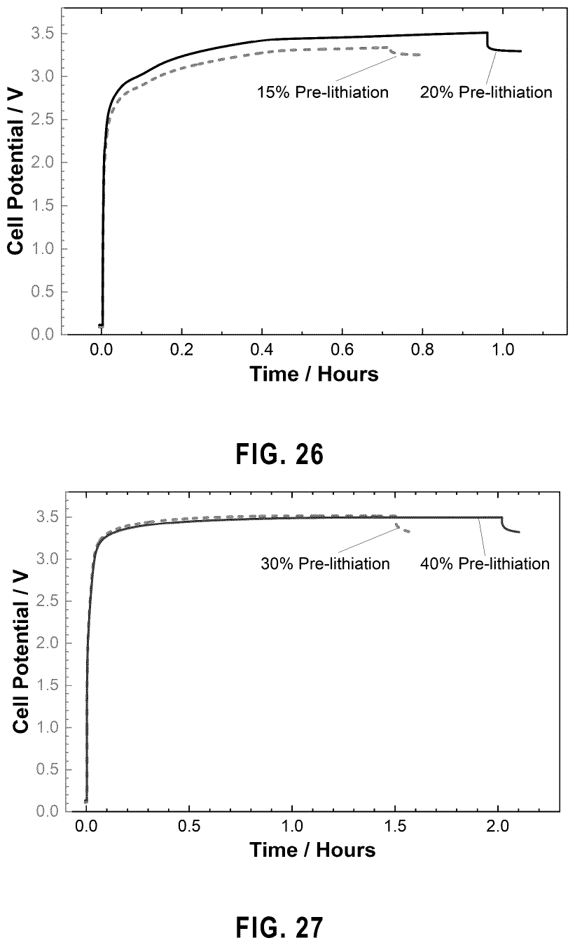

FIG. 26 shows the galvanostatic pre-lithiation of graphite anode with LFP counter electrode as Li source.

FIG. 27 shows the galvanostatic pre-lithiation of a SiOₓ anode with LFP counter electrode as Li source.

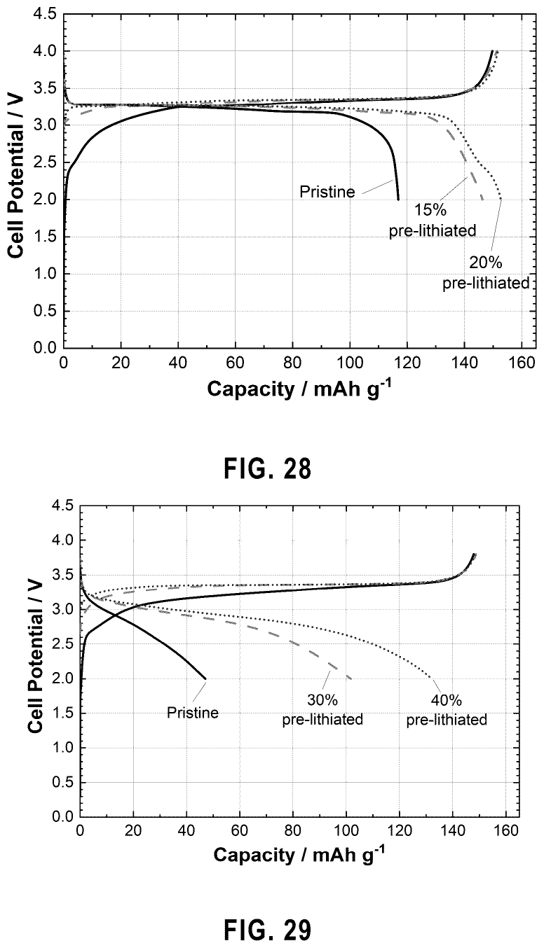

FIG. 28 compares the voltage vs capacity curve for the 1^{st} formation cycle of pristine and pre-lithiated graphite anodes.

FIG. 29 compares the voltage vs capacity curve for the 1^{st} formation cycle of pristine and pre-lithiated SiOₓ anodes.

### DETAILED DESCRIPTION OF THE INVENTION

Turning now to the invention in more details, there is provided a relithiated Li intercalation material for producing Li metal or an alloy thereof or for pre-lithiating an electrode material. In a related aspect, there is provided the use of a relithiated Li intercalation material for producing Li metal or an alloy thereof or for pre-lithiating an electrode material.

In embodiments, the use/relithiated Li intercalation material is for producing Li metal or an alloy thereof. In embodiments, Li metal is produced. In other embodiments, a lithium alloy is produced. Preferably, the Li metal or an alloy thereof is in the form of a film. Preferably, the Li metal or an alloy thereof is produced by electrodeposition.

In embodiments, the use/relithiated Li intercalation material is for pre-lithiating an electrode material. The electrode material can be any electrode material susceptible to undergo active lithium losses during the first cycle of a battery operation. In embodiments, the electrode material is an anode material, preferably graphite, Si, a silicon oxide (SiOₓ), silicon-carbon composite, carbon nanotube, or a mixture thereof.

Herein, a “Li intercalation material” is a material that is used for the reversible inclusion of Li ion (Li+) into its structure. Such materials are commonly used e.g., in the manufacture of cathodes for Li-ion batteries. The intercalation of Li+ ions into such materials will be referred to herein as “lithiation” of the material. The deintercalation of Li+ ions out of such materials will be referred to herein as “de-lithiation”. De-lithiation can be partial or complete. A complete de-lithiation means that all the Li+ ions that could de-intercalate under any specific set of conditions applied have done so. A partial de-lithiation means that only part of these ions de-intercalated.

Herein, “relithiation” simply refers to the lithiation of a Li intercalation material after it partial or complete de-lithiation. Therefore, a “relithiated Li intercalation material” is a partially or completely de-lithiated Li intercalation material that has been relithiated.

An example of a partially or completely de-lithiated Li intercalation material is a Li intercalation material that is degraded through Li loss. Such a material is produced by the method of the invention and can be relithiated and reused in the method of the invention. De-lithiated Li intercalation materials are also found in e.g., spent cathodes of used Li-ion batteries where it leads to capacity degradation. When a partially or completely de-lithiated Li intercalation material is relithiated, it recovers at least part of its lithium ions and thus its electrochemical properties. Preferably, the relithiated Li intercalation material has recovered during its relithiation at least 50%, preferably at least 75%, more preferably at least 85%, even more preferably at least 95%, and even more preferably at least 99% of previously deintercalated lithium ions.

The relithiated Li intercalation material is not particularly limited.

In embodiments, the relithiated Li intercalation material is a lithium phosphate or a lithium oxide. In preferred embodiments, the relithiated Li intercalation material is:
Li_{w}FePO₄ (wherein w≤1.1, preferably 1),
Li_{w}Fe₁₋ₓMnₓPO₄ (wherein w≤1.1, preferably w is 1; and 0<x≤1, preferably 0.2≤x≤50.4),
Li_{w}Mn₂O₄ (wherein w≤1.1, preferably w is 1),
Li_{w}Mn_{1.5}Ni_{0.5}O₄ (wherein w≤1.1, preferably w is 1),
Li_{4+z}Ti₅O₁₂ (wherein 0≤z≤3), or
NMC (Li_{w}Ni_{1-x-y-z}MnₓCo_{y}M_{z}O₂, wherein w≤1.3, 0≤x≤1, 0≤y≤1, and 0≤z≤1, and M is Al, Mg, Ti, Nb, Zr, W, Mo, Y, La, Ta or a mixture thereof).

Note that the Li intercalation material can contain an excess of lithium, meaning its Li content is above the stoichiometric ratio.

In preferred embodiments, the relithiated Li intercalation material is Li_{w}FePO₄.

In preferred embodiments, the relithiated Li intercalation material has been sourced from produced from the partially or completely de-lithiated Li intercalation material produced by the method of the invention. In other embodiments, the relithiated Li intercalation material has been sourced from spent electrodes, e.g. through battery recycling, and then relithiated.

### Production Anode

There is also provided a production anode for producing Li metal or an alloy thereof or for pre-lithiating an electrode material, the production anode comprising a relithiated Li intercalation material. Herein, this anode is called “production anode” to distinguish it from another anode to be described below, that is used for a relithiation electrolysis reaction, and that will be called “relithiation anode”. In a related aspect, there is provided the use of a production anode comprising a relithiated Li intercalation material for producing Li metal or an alloy thereof or for pre-lithiating an electrode material.

In embodiments, the use/production anode is for producing Li metal or an alloy thereof. In embodiments, Li metal is produced. In embodiments, a lithium alloy is produced. Preferably, the Li metal or an alloy thereof is in the form of a film. Preferably, the Li metal or an alloy thereof is produced by electrodeposition.

In embodiments, the use/production anode is for pre-lithiating an electrode material. The electrode material is as defined above.

The relithiated Li intercalation material is as defined above.

In embodiments, the production anode is for a Li production electrolysis reaction.

In embodiments, the production anode further comprises a current collector and the relithiated Li intercalation material is deposited on the current collector. This current collector can be made of any electronically conducting material, particularly any material used for current collectors in batteries. In embodiments, this current collector is a metal sheet, preferably made of Cu, Al, stainless steel, Ti or Ni, or is made of a conductive carbon material, or is a polymer-based current collector. In most preferred embodiments, this current collector is a coated with a primer coat to improve adherence of the Li intercalation material, such as a carbon-containing paint. In preferred embodiments, this current collector is a metal sheet made of stainless steel or Al, and preferably is a carbon coated Al current collector.

In preferred embodiments, the production anode is in the form of a film.

### Production Electrolysis Cell

There is also provided a production electrolysis cell for producing Li metal or an alloy thereof or for pre-lithiating an electrode material, the production electrolysis cell comprising:
a relithiated Li intercalation material used as a production anode,
a current collector or said electrode material used as a production cathode, and
a production electrolyte between the production cathode and the production anode, wherein the production electrolyte comprises a production lithium salt dissolved in a production solvent.

Herein, these cell, cathode, electrolyte, salt and solvent are called “production cell”, “production cathode” and so on, to distinguish them from the cell, cathode, electrolyte, salt and solvent described below, that are used for a relithiation electrolysis reaction, and that are called “relithiation cell”, “relithiation cathode” and so on.

In a related aspect, there is provided the use of this production electrolysis cell for producing Li metal or an alloy thereof or for pre-lithiating an electrode material. The electrode material is as defined above.

The relithiated Li intercalation material is as defined above.

The production anode is as defined above.

The production lithium salt can be any salt compatible with Li metal (or the alloy produced). In embodiments, the production lithium salt is lithium (flurosulfonyl)(trifluoromethanesulfonyl)imide, lithium 2-trifluoromethyl-4,5-dicyanoimidazolate (LiTDI), lithium 4,5-dicyano-1,2,3-triazolate (LiDCTA), lithium bis(pentafluoroethylsulfonyl)imide (LiBETI), lithium difluorophosphate (LiDFP), lithium chloride (LiCl), lithium bromide (LiBr), lithium hexafluoroarsenate (LiAsF₆), a lithium fluoroalkylphosphate [such as LiPF₃(CF₂CF₃)₃], lithium tetrakis(trifluoroacetoxy)borate (LiB(OCOCF₃)₄), lithium bis(1,2-benzenediolato (2-)-O,O′)borate LiB(C₆O₂)₂, lithium difluoro(oxalatol8)borate (LiBF₂(C₂O₄)), a compound of formula BF₂O₄Rₓ⁻(Rₓ=C₂₋₄alkyl), LiCF₃COO, LiF, LiNO₃, LiPFs, LiBF₄, LiBOB, LiClO₄, LiTFSi, CF₃SO₃Li, LiFSi, or any combination thereof, preferably LiCF₃COO, LiF, LiNO₃, LiPFs, LiBF₄, LiBOB, LiClO₄, LiTFSi, CF₃SO₃Li, LiFSi, or any combination thereof. In preferred embodiments, the production lithium salt is a combination of CF₃SO₃Li and LiFSi.

In embodiments, the production electrolyte further comprises one or more additives. Non-limiting examples of additives include additives that modify the morphology and/or properties of the Li metal or alloy, additives that influence the phase nucleation energy, additives that influence the Li or alloy deposition potential, and additives that influence the Li electrodeposition efficiency. In embodiments, the one or more additives is/are:
an unsaturated cyclic carbonate such as vinylene carbonate (VC),
a halogenated cyclic carbonate such as fluoroethylene carbonate (FEC),
a nitrate,
a Li polymerisation agent that comprises a saturated or unsaturated hydrocarbon chain, such as 1,8-diazabicyclo[5.4.0]undec-7-ene (DBU),
a Li passivating compound, and/or
an alkaline salt of an organic acid, such as lithium difluoro(oxalate)borate (LiDFOB) or Li oxalate.

The production solvent can be any such solvent typically used in Li ion batteries. In embodiments, the production solvent is an organic carbonate, an organic ester, an organic ether, an ionic liquid, or any combination thereof. In preferred embodiments, the production solvent is ethylene carbonate (EC), propylene carbonate (PC), fluoroethylene carbonate (FEC), gamma-butyrolactone (gBL), ethyl propionate, diethyl carbonate (DEC), dimethyl carbonate (DMC), ethyl methyl carbonate (EMC), dimethoxyethane (DME), fluoroether, tetrafluoroethyl tetrafluoropropyl ether (TTE), tetraethylene glycol dimethyl ether (TEGDME) or any combination thereof.

In embodiments, the production electrolysis cell is free of a membrane separating the production anode from the production cathode.

In embodiments, the production electrolysis cell adopts a roll-to-roll configuration. Indeed, the membrane-less configuration of the cell allows using a multi-layer roll-to-roll configuration such as that presented in e.g., FIG. 3. In such embodiments, the cell can further comprise one or more calendering devices, such as pairs of calendering rolls, e.g., at fixed intervals, to densify the electrodeposited Li or Li alloy film during its formation.

In embodiments, the production electrolysis cell is for pre-lithiating an electrode material. The electrode material is as defined above and is used as the production cathode. In use, the cell allows introducing lithium into the electrode material.

In alternative embodiments, the production electrolysis cell is for producing Li metal or an alloy thereof. The current collector is used as the production cathode. In embodiments, Li metal is produced. In embodiments, the lithium alloy is produced. Preferably, the Li metal or the alloy thereof is in the form of a film. Preferably, the Li metal or the alloy thereof is produced by electrodeposition. In use, the cell allows for the electrodeposition of a film of Li metal or the alloy thereof on the current collector used as the production cathode.

In preferred embodiments, operating conditions, such as agitation and/or temperature control, are used to modify the morphology of the produced Li metal/alloy.

In preferred embodiments, the current collector used as the production cathode is in the form of a foil.

The current collector used as the production cathode can be made of any electronically conducting material, particularly any material used for current collectors in batteries. In embodiments, the current collector is made of Cu, Al, protected Al, C, stainless steel, Ti, Zn, or Ni, or any alloy thereof, or is a polymer-based metallized current collector, or a combination thereof.

In preferred embodiments, the current collector is made of Cu or protected Al.

The current collector used as the production cathode may be protected by a protection layer or not. The surface of the current collector may be treated or modified to improve its lithiophilicity. The surface of the current collector may be treated or modified to have a 3D structure to improve the electrochemical performance of the Li metal (or alloy) layer in batteries or to increase its reaction rate e.g., when used for the fabrication of organolithium compounds.

In embodiments, the production electrolyte further comprises one or more alloying salts. An alloying salt is a salt of one or more metal that can form an alloy with lithium. When an alloying salt is used, a lithium alloy will be produced at the cathode. In alternative embodiments, the production electrolyte is free of an alloying salt, and therefore Li metal will be produced (rather than a lithium alloy) at the cathode.

In preferred embodiments, the alloy mainly comprises lithium. In preferred embodiments, the alloy comprises about 80 w/w % or more of Li, preferably about 85 w/w % or more of Li, more preferably about 90 w/w % or more of Li, yet more preferably about 95 w/w % or more of Li, based on the total weight of the alloy.

In embodiments, the alloying salt is a salt of one or more of Na, K, Mg, Ca, a transition metal, Al, Ga, or Sn; preferably Al or Mg.

In embodiments, the alloying salt is a (flurosulfonyl)(trifluoromethanesulfonyl)imide salt, a 2-trifluoromethyl-4,5-dicyanoimidazolate (TDI) salt, a 4,5-dicyano-1,2,3-triazolate (DCTA) salt, a bis(pentafluoroethylsulfonyl)imide (BETI) salt, a difluorophosphate (DFP) salt, a chloride salt, a bromide salt, a fluoride salt, a hexafluoroarsenate (AsF₆) salt, a fluoroalkylphosphate salt, a tetrakis(trifluoroacetoxy)borate salt, a bis(1,2-benzenediolato (2-)-0,0′)borate salt, a difluoro(oxalato)borate salt, a nitrate salt, a trifluoroacetate salt, a hexafluorophosphate salt, a tetrafluoroborate salt, a bis(oxalate)borate (BOB) salt, a perchlorate salt, a bis(trifluoromethanesulfonyl)imide (TFSI), a bis(fluorosulfonyl)imide (FSI) salt, a triflate salt, or a salt with an anion of formula: BF₂04Rₓ— (Rₓ=C₂₋₄alkyl).

### Method for Producing Li Metal/Alloy Thereof or for Pre-Lithiating an Electrode Material

There is also provided a method for producing Li metal or an alloy thereof or for pre-lithiating an electrode material, the method comprising:
a) providing a relithiated Li intercalation material, and
b) carrying out a Li production electrolysis reaction in a production electrolysis cell,
wherein the production electrolysis cell comprises:
   said relithiated Li intercalation material as a production anode,
   a current collector or said electrode material as a production cathode, and
   a production electrolyte between the production cathode and the production anode, wherein the production electrolyte comprises a production lithium salt dissolved in a production solvent, thereby electrodepositing Li metal or an alloy thereof on the current collector used as the production cathode or introducing lithium in said electrode material used as the production cathode thus producing a pre-lithiated electrode, and
thereby producing a partially or completely de-lithiated Li intercalation material.

In embodiments, the method is for producing Li metal or an alloy thereof. In embodiments, Li metal is produced. In embodiments, a lithium alloy is produced. In all these embodiments, the current collector is used as the production cathode. Preferably, the Li metal or an alloy thereof is in the form of a film.

In alternative embodiments, the method is for pre-lithiating an electrode material. The electrode material is as defined above and is used as the production cathode.

This method, along with the material, anode, cell, and various uses described in the previous sections, has several advantages.
It avoids the use of any membrane in the production electrolysis cell, which reduces cost, avoids contamination problems (especially water leakage) that might affect lithium purity, and down-times due to membrane maintenance. This allows adopting a multilayer roll-to-roll configuration, with optional calendering within the production electrolysis cell, leading to a major reduction in process space and increasing production speed.
It can use positive electrode material used previously in secondary battery (to produce a relithiated Li intercalation material) and allows recycling of used secondary batteries.
The method can be in a closed loop, which limits environmental impact and ensures safety.
The method allows the generation of homogeneous ultra-thin lithium metal electrode with high purity, without requiring further purification steps, and at low cost.
The method allows producing a Li film or foil without melting lithium.
The method does not require electrolysis at high temperature.
The lithium produced can be used in the fabrication of lithium-based primary and secondary batteries as well as in the fabrication of organolithium compounds and in the prelithiation of electrode material.
Regarding relithiation, the anodic reaction is oxygen evolution and not chlorine evolution (not corrosive and easy to handle).
The production lithium salt used can be a low-cost and easy to purify lithium salt such a lithium carbonate or even a low purity grade lithium carbonate or any other lithium salt.

In preferred embodiments, the relithiated Li intercalation material of the present method is as defined in the previous sections.

In preferred embodiments, the production anode of the present method is as defined in the previous sections.

In preferred embodiments, the production electrolysis cell of the present method is as defined in the previous sections.

Preferably, the current collector with the Li metal or the alloy thereof or the pre-lithiated electrode is washed, e.g., with an organic solvent, and dried before being used. Therefore, in embodiment, the method further comprises washing and drying the current collector with the Li metal or the alloy thereof or the pre-lithiated electrode produced at step b).

### Step b)

In step b), the relithiated Li intercalation material acts as an anode to supply Li⁺ ions for the electrodeposition of Li metal or an alloy thereof and for the pre-lithiation of the electrode material.

The Li metal or alloy thereof is deposited on a current collector that acts as a cathode. The Li metal or alloy thereof is typically electrodeposited on the current collector in the form of a thin film, which is generally of high purity.

Alternatively, Li is introduced into the electrode material that acts as a cathode.

The electrochemical reaction on the cathode and the anode in the production electrolytic cell are as follows:

Li⁺e⁻→Li Cathodic reaction:

Anodic reaction(when LiFePO₄ is used as the relithiated Li intercalation material):

LiFePO₄→FePO₄+e⁻+Li⁺

The partially or completely de-lithiated Li intercalation material is produced at the anode (FePO₄ in the above example) and it can be used as a starting material in step a) to provide a relithiated Li intercalation material, and thus eventually be reused in step b).

In embodiments, the Li production electrolysis reaction is carried out by controlling cell potential either between the production anode and the production cathode, or between the production cathode and a reference electrode.

In embodiments, the Li production electrolysis reaction is carried out by controlling cell current. In such embodiments, the Li production electrolysis reaction in controlled current mode can be carried out in direct mode, in a pulsating mode, either continuous or reverse. Also, the Li production electrolysis reaction in controlled current mode can be carried out at a fixed frequency or under a varying frequency.

In embodiments, step b) is carried out in a roll-to-roll configuration. Indeed, the membrane-less configuration of the electrochemical cell of step b) allows using a multi-layer roll-to-roll configuration such as that presented in e.g., FIG. 3. In such embodiments, the cell can further comprise one or more calendering devices, such as calendering rolls, e.g., at fixed intervals, to densify the electrodeposited Li film during its formation.

### Step a)

As noted above, a relithiated Li intercalation material is a partially or completely de-lithiated Li intercalation material that has been relithiated.

The partially or completely de-lithiated Li intercalation material is not particularly limited. It should be selected so it is stable in the conditions used for relithiation (electrolyte and such). In embodiments, the partially or completely de-lithiated Li intercalation material is a partially or completely de-lithiated lithium phosphate or lithium oxide, preferably partially or completely de-lithiated Li_{w}FePO₄, Li_{w}Mn₂O₄, Li_{4+z}Ti₅O₁₂, or NMC (Li_{w}Ni_{1-x-y}MnₓCo_{y}M_{z}O₂). In preferred embodiments, the partially or completely de-lithiated Li intercalation material is partially or completely de-lithiated Li_{w}FePO₄ (preferably wherein w is 1).

In embodiments, step a) is carried out in a roll-to-roll configuration.

In embodiments, step a) may comprise:
a′) providing a partially or completely de-lithiated Li intercalation material and a″) relithiating the partially or completely de-lithiated Li intercalation material, thereby producing a relithiated Li intercalation material.
   Then, the relithiated Li intercalation material is used in step b).

In preferred embodiments, the relithiated Li intercalation material is washed, preferably washed and dried, before being used in step b).

In embodiments, the partially or completely de-lithiated Li intercalation material is obtained from recycled spent batteries.

As noted above, in embodiments, (preferably when the process of the invention is repeated or is continuous), the partially or completely de-lithiated Li intercalation material of step a′) may be that produced at step b). Therefore, in embodiments, the method further comprises step c) repeating step a) and step b) one or more times, and using in steps a′) and a″), the partially or completely de-lithiated Li intercalation material produced in step b).

The partially or completely de-lithiated Li intercalation material may be relithiated at step a″) by any method known in the art.

Relithiation by Electrolysis Using an Electrolyte with a Lithium Salt

In preferred embodiments, step a″) comprises carrying out a relithiation electrolysis reaction in a relithiation electrolysis cell, wherein the relithiation electrolysis cell comprises:
the partially or completely de-lithiated intercalation material as a relithiation cathode,
a relithiation anode, and
a relithiation electrolyte between the relithiation cathode and the relithiation anode, wherein the relithiation electrolyte comprises a relithiation lithium salt dissolved in a relithiation solvent,
thereby relithiating the partially or completely de-lithiated intercalation material and producing the relithiated Li intercalation material.

In this electrolysis reaction, the relithiation lithium salt is used as a source of Li+ ions and the partially or completely de-lithiated intercalation material is used as a cathode. The general reactions are as follows:
Cathodic reaction (when FePO₄ is used as the de-lithiated Li intercalation material):

2Li⁺+2e⁻+2FePO₄→2LiFePO₄
Anodic reaction (when LiHCO₃ is used as the relithiation lithium salt):

2HCO₃⁻-2e⁻-½O₂+H₂O+2CO₂

The relithiation solvent can be any solvent, or mixture thereof, that can solubilize a lithium salt and support a compatible anodic reaction. In preferred embodiments, the relithiation solvent is water, which is an advantageous feature of the invention.

The material of the anode is not particularly limited. In embodiments, the relithiation anode is made of a material compatible with the anodic reaction, preferably compatible with the oxygen evolution reaction. In preferred embodiments, the relithiation anode is made of lead, platinum, titanium, another inert metal, or an alloy thereof, or graphite, etc. In preferred embodiments, the relithiation anode is a dimensionally stable anode.

In embodiments, the relithiation electrolyte further comprises one or more additives. Such additives typically do not participate in the relithiation electrolysis reaction. Non-limiting examples of additives includes additives that improve the electric conductivity properties of the relithiation electrolyte. In embodiments, the one or more additives is(are) a salt comprising an alkali metal cation other than Li or an alkaline earth metal cation (preferably potassium or magnesium) and an anion compatible with the relithiation electrolysis reaction (preferably sulfate or bicarbonate).

The relithiation salt can be any lithium salt that is soluble in the relithiation electrolyte, such LiFSI or LiTFSI.

In most preferred embodiments, the relithiation salt is a low-cost lithium salt. Examples of low-cost lithium salts include:
lithium salts that are mined, such as Li₂CO₃,
lithium salts that are economically prepared from salts that are mined, such as:
   LiHCO₃, which can be prepared from Li₂CO₃ as shows in Example 1;
   Li₂SO₄, which can be prepared from Li₂CO₃ as shown in Example 2;
   LiOH, which can be prepared from electrolysis of LiCl, Li₂SO₄ or LiHCO₃ or from Li₂CO₃ by a metathesis reaction with calcium hydroxide;
   LiNO₃, which can be made by treating Li₂CO₃ or LiOH with nitric acid;
   LiCH₃COO, which can be made by treating Li₂CO₃ with acetic acid; and
   Li₂C₂O₄, which can be made by treating Li₂CO₃ with oxalic acid.
lithium salts produced during the hydrometallurgical recycling of spent lithium batteries, which include e.g., many of salts already listed above; and
lithium salts recovered from lithium containing solutions, for examples geothermal brines, brine from salars, solutions from lithium ores processing and lithium battery recycling processes, which again include e.g., many of salts already listed above.

In preferred embodiments, the relithiation salt is easy to purify. An example of which is Li₂CO₃ which is easy to purify due to its low solubility (it will precipitate out of solution while impurities will remain solubilized) and easy to dry due to its low hygroscopicity (as opposed to LiCl which is more difficult to purify due to its very high water solubility and very hard to dry due to its high hygroscopicity).

In preferred embodiments, the relithiation salt is LiCO₃, LiHCO₃, LiOH, LiNO₃, LiOH, Li₂SO₄, LiCH₃COO, LiFSI, LiTFSI, or Li₂C₂O₄, or a mixture thereof, preferably the relithiation salt is LiHCO₃, or Li₂SO₄, or a mixture thereof, most preferably the relithiation salt is Li₂SO₄.

In embodiments in which the relithiation solvent is water, the relithiation salt can advantageously be a water-soluble relithiation salt. In most preferred embodiments, the relithiation salt is a water-soluble relithiation salt that has a water solubility higher than the water solubility of LiHCO₃. Non-limiting examples of such salts include: LiNO₃, Li₂SO₄, and LiCH₃COO. The conversion of Li₂CO₃ to these salts may represent some advantages compared to the use of Li₂CO₃ as LiHCO₃. For examples, the relithiation electrolytic cell may be operated at higher temperatures (since the solubility of these salts increases with higher temperatures, contrary to that of LiHCO₃), which along with their higher solubility may help operate the electrolytic cell at higher current densities (higher cell productivity and lower capital cost).

In embodiments, the relithiation salt is produced in situ i.e., in the relithiation electrolysis cell. In such embodiments, the method comprises adding a lithium precursor and a reactant to the relithiation electrolysis cell and allowing them to react to form the relithiation salt. In preferred embodiments, the lithium precursor and the reactant may be added to a salt formation compartment of the relithiation electrolysis cell that is in fluid communication with a main compartment of the relithiation electrolysis cell; the main compartment comprising the relithiation cathode and the relithiation anode.

In alternative embodiments, the relithiation salt is simply added to the relithiation electrolysis cell. This means that the relithiation salt is prepared before being added to the relithiation electrolysis cell. In such embodiments, the method may comprise a step of reacting the lithium precursor and the reactant in a separate reactor to obtain the relithiation salt and then adding the relithiation salt to the relithiation electrolysis cell.

In all cases, the choice of lithium precursor and reactant will of course depend on the desired relithiation salt. For example, LiHCO₃, Li₂SO₄, LiNO₃, and LiCH₃COO can be prepared by reacting Li₂CO₃ with CO₂, H₂SO₄, nitric acid, or acetic acid, respectively. In such embodiments, the lithium precursor is therefore Li₂CO₃, LiOH, or a mixture thereof as desired. Similarly, in such embodiments, the reactant is therefore CO₂, H₂SO₄, nitric acid, acetic acid, oxalic acid, or an acid form of a sulfonyl-imide salt, or a mixture thereof as desired. In preferred embodiments, the lithium precursor is Li₂CO₃. In preferred embodiments, the reactant is CO₂ or H₂SO₄, or a mixture thereof. In most preferred embodiments, the reactant is CO₂. In alternative most embodiments, the reactant is H₂SO₄.

Interestingly, when LiHCO₃ is used as the relithiation salt, the anodic reaction in the relithiation cell produces CO₂, which can be reused to produce more LiHCO₃ from Li₂CO₃.

Also interestingly, when Li₂CO₃ is used as the lithium precursor for an Li electrolyte comprising salts such as LiNO₃, Li₂SO₄, or LiCH₃COO as a relithiation salt, there is no need for the addition of an acid to make-up for the H+ ions consumed in the conversion of the carbonate salt as H+ are regenerated at the anode.

In embodiments, the relithiation electrolysis reaction is carried out by controlling cell potential either between the relithiation anode and the relithiation cathode, or between the relithiation cathode and a reference electrode.

In embodiments, the relithiation electrolysis reaction is carried out by controlling cell current. In such embodiments, the relithiation electrolysis reaction in controlled current mode can be carried out in direct mode, in a pulsating mode, either continuous or reverse. Also, the relithiation electrolysis reaction in controlled current mode can be carried out at a fixed frequency or under a varying frequency.

### Relithiation Using a Reducing Agent

In alternative embodiments, step a″) comprises carrying out a relithiation reaction as described in WO 2021/092692, incorporated herein by reference.

In preferred embodiments, the method comprises (i) adding the partially or completely de-lithiated intercalation material to a solution containing a reducing agent and a relithiation salt in a solvent; thereby relithiating the partially or completely de-lithiated intercalation material and producing the relithiated Li intercalation material. The reaction is as follow:

2Li⁺+2R-Fe²⁺+2FePO₄→2LiFePO₄+2R′-Fe³⁺

(wherein R and R′ are anionic molecules or complexing agents).

In embodiments, the method further comprises (ii) separating the relithiated Li intercalation material from the solution; and preferably (iii) electrochemically treating the solution separated in step (ii) to regenerate the reducing agent.

The relithiation salt is as described in the previous section.

In embodiments, the reducing agent is the reducing member of a redox couple exhibiting a lower redox potential than that of the partially or completely de-lithiated intercalation material.

According to one embodiment, the redox couple comprises an Fe(Ill)/Fe(II) complex, for example, chosen from [Fe(CN)₆]³⁻/Fe(CN)₆]⁴⁻, [Fe(nta)]/[Fe(nta)]⁻, [Fe(tdpa)]²⁻/Fe(tdpa)]³⁻, [Fe(edta)]⁻/[Fe(edta)]²⁻, [Fe(citrate)]/[Fe(citrate)]⁻, [Fe(III)-TEA]/[Fe(II)-TEA], and [Fe(oxalate)]⁺/[Fe(oxalate)].

According to one embodiment, step (i) further comprises a step of deoxygenation of the solution.

According to one embodiment, steps (i) and/or (iii) are carried out in the absence of oxygen.

In another embodiment, the method further comprises a step of adjusting the pH of the solution to a pH suitable for the electrochemically active material of step (i) (for example, for FePO₄, the pH is adjusted between 5 and 9, preferably between 6 and 7.5).

In another embodiment, the solvent is an aqueous solvent.

According to one embodiment, step (iii) of electrochemical treatment is carried out in an electrolytic cell by passing a current between at least one cathode and at least one anode. The reaction at play at step (iii) are:

2R-Fe³⁺+2e⁻→2R′—Fe²⁺ Cathodic reaction:

2OH⁻-2e−→½O₂+H₂O Anodic reaction:

In one embodiment, the electrolytic cell includes at least one ionic or non-ionic separator installed between the anode and the cathode in order to protect the regenerated reducing agent. In another embodiment, the electrolytic cell further includes a system for keeping the solution deoxygenated, for example, the system including maintaining an oxygen-free gas in the electrolytic cell, such as carbon dioxide, nitrogen or argon.

In embodiments, the step (iii) is carried out by controlling cell potential either between the anode and the cathode, or between the cathode and a reference electrode.

In embodiments, the step (iii) is carried out by controlling cell current. In such embodiments, the relithiation reaction in controlled current mode can be carried out in direct mode, in a pulsating mode, either continuous or reverse. Also, the relithiation reaction in controlled current mode can be carried out at a fixed frequency or under a varying frequency.

Uses of the Current Collector with the Li Metal or Alloy Thereof and/or the Pre-lithiated Electrode Produced at Step b)

The current collector with the Li metal or the alloy thereof and the pre-lithiated electrode produced at step b) can be used for many different purposes. In embodiments, the current collector with the Li metal or the alloy thereof or the pre-lithiated electrode is used:
as a negative electrode in a primary or a secondary Li battery, preferably a lithium-ion battery or an all-solid-state battery,
as a source of Li metal or an alloy for the prelithiation of electrode material, and
as a source of Li metal or an alloy thereof for the manufacture of an energy storage system.

In embodiments, the current collector with the Li metal or the alloy thereof is used as a source of Li metal or an alloy thereof for the preparation of an organolithium compound.

In embodiments, the current collector with the Li metal or the alloy thereof thereof is laminated to modify its morphology, density or thickness. The lamination may be carried out by cold rolling at room temperature or at a higher temperature. If the lamination temperature is higher than the Li melting point, a substrate with a high lithiophilicity may advantageously be used. Non-limiting examples of such substrates include Si, Sn, Zn, Al, ZnO, Cu₂O, CuO, and Cr₂O₃.

In embodiments, the current collector with the Li metal or the alloy thereof is treated to have a 3D structure. Such structure can be used to improve the electrochemical performance of the Li layer in batteries or to increase its reaction rate when used for the preparation of organolithium compounds.

In embodiments, the current collector with the Li metal or the alloy thereof is surface treated to improve its electrochemical performance in batteries. For example, a thin layer of an element, such as Zn or Al or one of their alloys, can be deposited on the Li layer. Different deposition methods such as physical vapor deposition (PVD) or spray coating can be used.

In other embodiments, the current collector with the Li metal or the alloy thereof is used to produce an organolithium compound. In preferred such embodiments, it is reacted with a reagent, such as an alkyl halide, to produce the organolithium compound. Such compounds are important reagents used as polymerization initiator in the production of elastomers or as strong base reagents in synthesis of organic and pharmaceutical molecules. As example, 1-chlorobutane dissolved in an organic solvent (such as cyclohexane) can be reacted with the electrodeposited Li metal or alloy thereof to produce n-butyllithium. In more specific embodiments, the method further comprises the step of transferring the current collector with the electrodeposited Li metal or alloy thereof produced at step b) to a separate reactor, preferably in roll-to-roll mode, reacting the electrodeposited Li metal or alloy thereof with a reactant in said separate reactor to produce an organolithium compound.

### Lithium Electrode Produced by the Above Method

There is provided a lithium electrode comprising the above current collector with the Li metal or the alloy thereof (i.e., as produced by the above method).

There is also provided a lithium battery comprising this lithium electrode. In preferred embodiments, the lithium battery is a lithium-ion battery or an all-solid-state battery.

### Definitions

The use of the terms “a” and “an” and “the” and similar referents in the context of describing the invention (especially in the context of the following claims) are to be construed to cover both the singular and the plural, unless otherwise indicated herein or clearly contradicted by context.

The terms “comprising”, “having”, “including”, and “containing” are to be construed as open-ended terms (i.e., meaning “including, but not limited to”) unless otherwise noted. In contrast, the phrase “consisting of” excludes any unspecified element, step, ingredient, or the like. The phrase “consisting essentially of” limits the scope to the specified materials or steps and those that do not materially affect the basic and novel characteristic(s) of the invention.

Recitation of ranges of values herein are merely intended to serve as a shorthand method of referring individually to each separate value falling within the range, unless otherwise indicated herein, and each separate value is incorporated into the specification as if it were individually recited herein. All subsets of values within the ranges are also incorporated into the specification as if they were individually recited herein.

All methods described herein can be performed in any suitable order unless otherwise indicated herein or otherwise clearly contradicted by context.

The use of any and all examples, or exemplary language (e.g., “such as”) provided herein, is intended merely to better illuminate the invention and does not pose a limitation on the scope of the invention unless otherwise claimed.

No language in the specification should be construed as indicating any non-claimed element as essential to the practice of the invention.

Herein, the term “about” has its ordinary meaning. In embodiments, it may mean plus or minus 10% or plus or minus 5% of the numerical value qualified.

Unless otherwise defined, all technical and scientific terms used herein have the same meaning as commonly understood by one of ordinary skill in the art to which this invention belongs.

Other objects, advantages and features of the present invention will become more apparent upon reading of the following non-restrictive description of specific embodiments thereof, given by way of example only with reference to the accompanying drawings.

### DESCRIPTION OF ILLUSTRATIVE EMBODIMENTS

The present invention is illustrated in further details by the following non-limiting examples.

### Example 1—Apparatus to Carry Out the Method of the Invention Using LiHCO₃ Produced In Situ as the Relithiation Salt

A schematic of an embodiment of the process of the invention is presented in FIG. 1.

A relithiation electrolysis reaction is carried out in a relithiation electrolysis cell (10) comprising a relithiation electrolyte and equipped with a stirrer (12). In FIG. 1, the relithiation electrolyte comprises LiHCO₃ as the relithiation salt.

This relithiation salt LiHCO₃ is produced in relithiation electrolysis cell (10) by reacting a lithium precursor, that is Li₂CO₃ powder (14), with a reactant, in the present case CO₂ which is added to the electrolyte using a bubbler (16). A wall (18) divides relithiation electrolysis cell (10) into a salt formation compartment (20) and a main compartment (22) in fluid connection with one another.

The main compartment (22) of the relithiation electrolysis cell (10) comprises a relithiation anode (24) and a partially or completely de-lithiated intercalation material (26) serving as a relithiation cathode. After the relithiation electrolysis reaction, the partially or completely de-lithiated intercalation material (26) is relithiated forming a relithiated Li intercalation material (28). In the present example, LiFePO₄ (LFP) on a metallic foil is used as the intercalation material that is partially or completely de-lithiated and relithiated.

This step is carried out in a roll-to-roll configuration. The partially or completely de-lithiated intercalation material (26) provided by roll (30) is thus fed to the relithiation electrolysis cell (10) and the relithiated Li intercalation material (28) is drawn out of the relithiation electrolysis cell (10) and collected on roll (32) using intermediate rolls (34, 36, 38, and 40). A series of washing, rinsing, wringing, and drying steps may be included in the roll-to-roll unit.

The roll (32) of relithiated Li intercalation material (28) is transferred to a production electrolysis cell (42) as shown by arrow B. The production electrolysis cell (42) uses the relithiated intercalation material (28) as a production anode, a current collector (44) as a production cathode, and a production electrolyte. In the present example, the current collector (44) is a treated or untreated Cu foil.

In production electrolysis cell (42), lithium is electrodeposited on the current collector (44) producing a Li-covered current collector (46) and the relithiated Li intercalation material (28) is de-lithiated (partially or completely) thus regenerating the Li intercalation material (28). The Li intercalation material (28) can then be returned to the relithiation electrolysis cell (10) for relithiation as shown by arrow A.

This step is also carried out in a roll-to-roll configuration. The relithiated Li intercalation material (28) is fed by roll (32) and the partially or completely de-lithiated intercalation material (26) is collected on roll (30) using intermediate rolls (48, 50, 52, and 54). Similarly, the current collector (44) is fed by roll (56) and the Li-covered current collector (46) is collected on roll (58) using intermediate rolls (60, 62, and 64). A series of washing, rinsing, wringing, and drying steps may be included in the roll-to-roll unit.

The Li-covered current collector (46) can be used or transformed in different ways. Arrow C shows that the roll (58) of Li-covered current collector (46) can be cold-rolled using cold-rolling rolls (60) to form a cold-rolled Li-covered current collector (62) that is collected on roll (64) via intermediate rolls (66, 68). Arrow D shows that the roll (58) of Li-covered current collector (46) can be hot-rolled using hot-rolling rolls (70) to form a hot-rolled Li-covered current collector (72) that is collected on roll (74) via intermediate rolls (76, 78).

In FIG. 1, the intercalation material used in the production step is LiFePO₄ (LFP) on an aluminum substrate. The de-lithiated intercalation material produced (in this figure, FP) is returned to the relithiation step to be relithiated in a cathodic reaction in aqueous media with the oxygen evolution as the anodic reaction as follows:

2Li⁺2e⁻+2FePO₄→2LiFePO₄ Reaction 1(cathodic reaction):

2HCO₃⁻→½O₂+H₂O+2CO₂+2e⁻ Reaction 2(anodic reaction):

The source of Li ions in this case is Li₂CO₃ dissolved in water as LiHCO₃ by bubbling CO₂ in the Li₂CO₃ slurry in water according to the following reaction:

Li₂CO₃+CO₂+H₂O→2LiHCO₃ Reaction 3:

The advantage of dissolving Li₂CO₃ as LiHCO₃ is the higher solubility of LiHCO₃ compared to that of Li₂CO₃.

### Example 2—Apparatus to Carry Out the Method of the Invention Using Li₂SO₄ Produced In Situ as the Relithiation Salt

FIG. 2 shows another embodiment of the process of the invention, which is based on the conversion of Li₂CO₃ to Li₂SO₄. Thus, FIG. 2 is quite similar to FIG. 1, except that the bubbler is absent and the relithiation electrolyte in the relithiation electrolysis cell (10) is different. The source of Li ions in this case is Li₂CO₃ dissolved in water as Li₂SO₄ reacting it with H₂SO₄ acid following reaction:

Li₂CO₃+H₂SO₄→Li₂SO₄+CO₂+H₂O Reaction 6:

The cathodic reaction is the same as in the case of electrolyte based on LiHCO₃ (Example 1). However, in the anodic reaction, other than oxygen evolution, H+ ions are generated which contribute to the regeneration of H₂SO₄ needed in the conversion of Li₂CO₃ into Li₂SO₄.

2Li⁺+2e⁻+2FePO₄→2LiFePO₄ Reaction 7(cathodic reaction):

H₂O-2e⁻→½O₂+2H⁺ Reaction 8(anodic reaction):

Therefore, when the Li₂CO₃ is added to a dedicated compartment of the relithiation electrolytic cell, there is no need for the addition of any acid to the solution during the continuous addition of Li₂CO₃ powder to the cell thanks to the continuous generation of H+ ions at the anode.

### Example 3: Roll-to-Roll Li Electrodeposition Cell Configuration

FIG. 3 shows another embodiment of an apparatus to carry out the method of the invention. In this case, the electrodeposition of Li (step b) is carried out in a roll-to-roll configuration. The absence of any membrane in the production electrolysis cell (42), which is one of the advantages of the invention, allows using a multi-layered electrolysis configuration, which is very difficult to achieve if the Li electrodeposition cell needs to have separate anolyte and catholyte compartments as described in US 2021/0381115 A1 as well as in US 2022/0367874 A1.

In FIG. 3, two rolls (32) feed relithiated Li intercalation material (28) to the production electrolysis cell (42). Similarly, two rolls (30) collect the partially or completely de-lithiated intercalation material (26). This is done via several intermediate rolls (76). Also, the current collector (44) is fed by roll (56) and the Li-covered current collector (46) is collected on roll (58) via intermediate rolls (78) and pairs of calendering rolls (80).

Indeed, the cell is also equipped with several pairs of calendering rolls that allow densifying the Li metal layer during its electrodeposition while it is still immerged in the electrolyte. This also allows also to minimize inclusions in the Li film and increase its purity.

### Example 4: Thin Film Li Electrodeposition in Pouch Cell

A thin film of Li was electrodeposited on an ultra-thin current collector using LFP as source of lithium ions in a pouch cell assembly. We confirmed the production of a lithium layer that was around 11.5 μm thick.

A thin film of metallic lithium was obtained by electrodeposition in a dual lithium salt electrolyte dissolved in a carbonate based solvent. The electrolyte solution was made by mixing ethylene carbonate (EC) with diethylene carbonate (DEC) in an Ar filled glove box at a 50/50 volume ratio. Then, lithium triflate (LiCF₃COO) and lithium bis(fluorosulfonyl)imide (LiFSI) were added to the solvent mixture at concentrations of 0.9 M and 0.1 M respectively. The suspension was agitated vigorously until complete dissolution of the salts. To ensure stability of the electrolyte with lithium metal and to remove any trace of water, a small stripe of bare metallic lithium was immersed in the electrolyte for at least 24 h before further usage.

The LiFePO₄ (LFP) anode was prepared by mixing pristine carbon-coated LFP with carbon conductive materials (carbon fiber (VGCF-H) and carbon black (Denka Black)) and polymer binder (polyvinylidene fluoride (PVDF)) in a weight ratio of 91:2.5:2.5:4. The mixture was dispersed in N-methyl-2-pyrrolidone (NMP) in a planetary centrifugal mixer until perfectly uniform slurry was obtained. The slurry was coated on a 15 μm thick carbon-coated aluminum foil using a doctor blade and dried at 80° C. for 24 h. The coating was densified by roll-pressing. The total specific loading of the electrode is 10 mg/cm².

The electrodeposition of Li was performed in a pouch cell under galvanostatic conditions. The cell was assembled using a dried 4.5 μm thick copper foil as cathode, the previously mentioned LFP coated on Al foil as anode and a polypropylene (PP) membrane (Celgard 3501) as separator. Both electrodes had a 25.5 cm² active surface area. The pouch cell was filled with the electrolyte prepared previously, vacuum sealed, and installed between pressing plates compressing the pouch cell at about 75 psi. The galvanostatic electrolysis was performed at 25° C. with a constant current of 0.5 mA/cm² for a total passed charge of around 129 C. The applied current and potential response of this plating sequence is shown in FIG. 4.

After completion of the electrodeposition, the lithium cathode was recovered by opening the pouch cell in a fume hood of a dry room. The Cu/Li electrode was washed three times with tetrahydrofuran (THF) and one time with dimethoxyethane (DME). All solvents used were anhydrous. The lithium was then calendered between two stainless steel rolls at room temperature at a speed of 10 mm/s while protecting the integrity of the lithium by placing the electrode between an 11 μm copper sheet below and a 20 μm polypropylene (PP) sheet with another 11 μm copper sheet on top. The calendered lithium was placed under vacuum for 12 hours to make sure that all the DME was evaporated. The resulting thin electrode sheet is composed of a lithium layer of around 11.5 μm thick on a copper sheet of 4.5 μm.

### Example 5: Relithiation of a De-Lithiated LFP Anode

In this example, an electrode of de-lithiated LFP (FP) is obtained from a coin cell used to deposit Li in conditions similar to those of Example 4 and is then relithiated in an aqueous Li₂SO₄ electrolyte. We confirmed this led to the complete relithiation of the electrode in an aqueous media.

The initial LFP electrode used during the Li plating consist of a 16 mm diameter disc made of a mixture of LFP, conductive carbon, and PVDF coated on a 15 μm Al foil as described in Example 4, with an active loading of 9.1 mg/cm². Considering a theoretical capacity of 170 mAh/g LFP, the LFP anode has a charge capacity of 3.02 mAh. Then, lithium was electroplated in a CR2032 coin cell by discharging the LFP anode against a 4.5 μm Cu foil cathode at a constant current of 1 mA/cm² during 1.29 hr in the dual-salt electrolyte described in Example 4. FIG. 5 shows the evolution of potential with time recorded during this electrolysis. The total charge passed through the cell was 2.6 mAh. In this respect, based on coulombic calculation, the LFP electrode was discharged at 86%.

In a second step, the de-lithiated LFP electrode (called FP electrode) was recovered from the coin cell and rinsed three times in THF, one time in hexane and then dried before relithiation. The FP electrode was assembled in a supporting holder of 1 cm² active area. A 0.25M Li₂SO₄ solution was prepared from ACS grade lithium sulfate and deionised water and adjusted to pH 6 with diluted H₂SO₄. The relithiation of FP electrode was carried out by placing the FP cathode and a dimensionally stable anode (DSA) in the lithium sulfate electrolyte. A constant potential of −0.05 V vs NHE was applied between the cathode and an Ag/AgCl reference electrode (3.5M KCl). After one hour, a total charge of 1.77 mAh was passed through the FP electrode. FIG. 6 shows the cumulative charge as a function of time. The degree of conversion (from FP to LFP) of the electrode before and after relithiation was confirmed by X-ray diffraction analysis (XRD), as shown in FIG. 7. The spectra of the electrode before relithiation shows a partly de-lithiated electrode at 12.5%, which is in good agreement with the coulombic data from Li electrodeposition. The spectra of the electrode after relithiation are similar to that of pristine LFP, confirming the complete relithiation of the electrode.

### Example 6: Electrochemical Properties of Electrodeposited Li

The lithium covered copper foil electrode produced in Example 4 was used as negative electrode in a Li rechargeable battery. We confirmed that coin cells prepared with electrodeposited Li showed significantly higher charge-discharge stability than cells prepared with a commercially available ultrathin Li foil prepared by PVD.

First, a lithium anode disc of 14 mm in diameter was punched between two PP sheets from the calendered lithium obtained in Example 4.

A cathode was prepared by mixing Li(Ni_{0.8}, Mn_{0.1}, Co_{0.1})O₂ (NMC811), PVDF, DENKA black, and graphite in NMP in a proportion of 94% w/w, 3% w/w, 2% w/w, and 1% w/w respectively, using a Thinky™ centrifugal mixer. The obtained slurry was then coated on a carbon coated aluminum. The coating was dried at a temperature of 130° C. and laminated to a density of 3.3 g/cm³. The obtained cathode foil was then dried again at 120° C. under vacuum for 12 hours.

A disc of 14 mm diameter was punched from the cathode foil and mounted in a coin cell CR2032 made of stainless steel. The cathode and the calendered Li anode described earlier were separated by a Celgard 3501 membrane. The cell was filled with a 60 μL of 1.7M LiFSI salt dissolved in a mix of DME-TTE (1.2:3 molar ratio).

Two cells were produced in this fashion.

The cell was cycled at a temperature of 25° C. at a charge and discharge rate of C/10 for three cycles for the formation and then at a rate of C/3 for the stability test. The potential limits were set to 2.7 V and 4.2 V vs Li⁺/Li⁰.

To compare the performance of the electrodeposited Li with that of commercially available ultrathin Li foils, two reference cells were made using as an anode, a commercially available 5 μm thin Li foil deposited directly onto a copper foil by PVD. These cells were tested in the same conditions against the same NMC. The specific capacity as a function of charge-discharge cycles is shown in FIG. 8.

As it may be seen, the two coin cells prepared with electrodeposited Li show significantly higher charge-discharge stability than the two cells prepared with the previously described commercially available ultrathin Li foil prepared by PVD.

### Example 7: Electrodeposition of Thin Li on Copper Foil in Electrochemical Cell without Membrane

A thin film of Li was electrodeposited on a copper foil (cathode) using an undivided (without any membrane separating the cathode and the anode compartments) beaker type electrochemical cell (Tait cell from Ametek® SI).

Then, the obtained Li was used as negative electrode in a Li rechargeable battery. We confirmed that the method of the invention can be carried out 1) in a membrane-less electrochemical cell and 2) at high current density (4 mA/cm²).

More specifically, the cell consisted of a bottom plate on which a flat 4.5 μm copper foil cathode was placed, a glass tube (6.5 cm inner diameter) that is placed on the copper foil, and a top plate that hold tightly the assembly through long screws on nuts. The sealing between the Cu foil and the glass body is ensured by a gasket.

The electrodeposition was performed in an Ar filled glove box (H₂O<0.1 ppm; O₂<0.1 ppm) using an electrolyte solution composed of ethylene carbonate (EC) and diethylene carbonate (DEC) at a volume ratio of 50/50 with lithium triflate (LiCF₃COO) and lithium bis(fluorosulfonyl)imide (LiFSI) electrolytic salts at a concentration of 0.6 M and 0.4 M respectively. The anode consisted of a stainless-steel disc of 25 cm² coated with an LFP based slurry with the same formulation as that described in Example 4 with an active material loading of 23 mg/cm². The anode was fixed on an agitator shaft and positioned at a distance of 0.6 cm from the cathode foil. A volume of 20 ml of the carbonate-based electrolyte was added to the cell. The active surface of the cathode was 25.5 cm². The galvanostatic electrolysis was performed at room temperature, at a rotation speed of the anode of 50 rpm, and at a constant current density of 4 mA/cm² for 22 min. FIG. 9 shows the variation of the cell potential as a function of time.

The resulting electrodeposited lithium was cleaned and calendered according to the same steps as in Example 4, before thickness measurement, which revealed a Li thickness of around 9 μm. The aspect of the deposit before and after calendering is shown in FIGS. 10A and B, while FIG. 11 shows the cross-section of calendered Li under scanning electron microscopy.

The obtained Li was then used as negative electrode in a Li rechargeable battery. First, a lithium anode disc of 14 mm in diameter was punched between two PP sheets from the calendered lithium.

A cathode was prepared by mixing LFP with PVDF, DENKA black, and graphite in NMP in a proportion of 89% w/w, 5% w/w, 3% w/w, and 3% w/w respectively, using a Thinky™ centrifugal mixer. The obtained slurry was then coated on a carbon coated aluminum then dried at a temperature of 120° C. The obtained cathode foil was then dried again at 120° C. under vacuum for 12 hours.

A disc of 14 mm diameter was punched from the cathode foil and mounted in a coin cell CR2032 made of stainless steel. The cathode and the calendered Li anode described earlier were separated by a Celgard™ 3501 membrane. The cell was filled with a 60 μL of 1.7M LiFSI salt dissolved in a mix of DME-TTE (1.2:3 molar ratio).

The cell was cycled at a temperature of 25° C. at a charge and discharge rate of C/24 for one cycle for the formation and then at a rate of C/10 for two more cycles of formation, and finally cycled at a discharge rate of 1C and a charge rate of C/3 for the stability test. The potential limits were set to 2 V and 4 V vs Li⁺/Li⁰. FIG. 12 compares the cycling stability of the obtained Li and a Li foil prepared by PVD.

### Example 8: Electrodeposition of Thin Film Li on a Treated Copper Foil in Electrochemical Cell without Membrane

The electrodeposition of thin Li film was performed on various types of foils for enhanced Li deposition.

The deposition was performed using the same experimental set-up used in Example 7 (cell without membrane, a rotating LFP coated anode and the same electrolyte formulation).

Electrochemical properties of each obtained Li were compared to the commercially available PVD Li cathode as per Example 7. FIG. 13 shows the cycling stability of each sample. The electrodeposited lithium had performances that were better than or similar to those of the PVD Li.

### Example 8.1: Copper Silver Substrate

A cathode consisting of a thin copper foil of 9 μm coated with a thin layer of silver was prepared. The silver coating was prepared by washing the copper foil in acetone, soaking the foil in 1M sulfuric acid for 1 min at room temperature, rinsing the acid with water and finally by soaking the cleaned Cu foil in an electroless silver plating solution for 10 seconds. The obtained treated current collector was then dried before being used as current collector in the membrane less cell described in Example 7. The applied current was 4 mA/cm² during 22 min with an active cathodic area of 25.5 cm². The cell potential evolution as a function of time is shown in FIG. 14. The resulting electrodeposited lithium was cleaned and laminated according to the same steps as in Example 7 before thickness measurement which revealed a Li thickness of around 6.5 μm and electrochemical cycling.

### Example 8.2: Brass Foil Substrate

A brass foil was used to demonstrate the lithiophilic properties of this alloy. The foil is a commercially available brass foil composed of 68% w/w Cu and 32% w/w Zn. After being cleaned with acetone and properly dried, the 20 μm brass foil was used as a cathode in an electrodeposition cell of Li under similar conditions as those for the silver-plated Cu foil described above. The cell potential evolution as a function of time is shown in FIG. 15. The resulting electrodeposited lithium was cleaned and laminated according to the same steps as in Example 7 before thickness measurement which revealed a Li thickness of around 12 μm and electrochemical cycling.

### Example 8.3: 3D Textured Ni Foil Substrate

The Li electrodeposition was performed on a commercially available textured Ni foil. The foil presents a high surface area due to its 3D textured Ni dendritic formation. Similar to the preceding examples, the 3D foil was used as the cathodic substrate. The deposition was performed in the same conditions as those for the CuAg or the brass foil. The cell potential evolution as a function of time is shown in FIG. 16. The resulting electrodeposited lithium was cleaned and laminated according to the same steps as in Example 7 before thickness measurement which revealed a Li thickness of around 9 μm.

### Example 9: Electrodeposition of Thin Li on Metalized Polymer in Electrochemical Cell without Membrane

A metalized polymer was used as the electrodeposition substrate. The results show that this substrate can be successfully used.

The metalized polymer consisted of a 50 μm thick polyethylene terephthalate film coated with a thin film of Cu deposited by physical vapor deposition (PVD).

The Li electrodeposition was performed in the same electrolyte and with the same set-up as for example 8.2. A current density of 4 mA/cm² was applied for 13 min.

The cell potential evolution as a function of time is shown in FIG. 17. The obtained Li foil is shown in FIG. 18.

### Example 10: Relithiation of the De-Lithiated LFP Anode from the Above Tait Cell

The electrode of de-lithiated LFP (FP) resulting from the anodic discharge of LFP during the Li electrodeposition described in the example 8.2 on brass substrate was relithiated in an aqueous LiHCO₃ electrolyte. Then, the relithiated electrode was used to produce Li. We confirmed complete relithiation of the electrode and its successful reuse to produce Li.

The initial LFP electrode used during the Li plating of Example 8.2 consisted of a 25 cm² and 20 mm thick stainless-steel disc coated with a mixture of LFP, conductive carbon, and PVDF as described in Example 7, with an active loading of 22.4 mg/cm².

Considering a theoretical capacity of 170 mAh/g LFP, the LFP anode has a charge capacity of 97 mAh. The total electrodeposition charge is 36.7 mAh corresponding to a de-lithiation extent of about 38% of the LFP anode. The evolution of the cell potential with time corresponds to the FIG. 19.

This de-lithiated LFP electrode (called FP electrode) was retrieved from the cell of Example 8.2 and rinsed three times in THF, one time in hexane and then dried before relithiation. The FP electrode was fixed on an agitator and then immersed in a 0.5M LiHCO₃ solution at a circumneutral pH. This electrolyte was prepared from ACS grade lithium carbonate by solubilizing the lithium salt in deionised water in a pressurized reactor under a CO₂ partial pressure of 2 atm. A platinised titanium mesh of about 25 cm² was used as anode. A constant current of 4 mA/cm² was applied between the cathode and the anode. The cathode potential was monitored with an Ag/AgCl reference electrode (3.5M KCl at 0.198 V vs NHE) immersed just beside the cathode. The current was stopped when the cathode potential dropped below −0.5 V vs NHE indicating a high degree of lithiation (after 21 min).

The cumulative coulombic charge corresponds to 34.3 mAh, FIG. 19 shows the current density and the cathode potential as a function of time. The relithiation of the electrode was confirmed by FTIR as shown in FIG. 20. Hence, the spectrum of the electrode before and after the relithiation corresponds the partially de-lithiated and fully lithiated state of LFP respectively. The spectra of the electrode after relithiation are similar to that of pristine LFP, confirming the complete relithiation of the electrode.

The LFP electrode previously relithiated was reused as anode in a second Li electrodeposition. The electrochemical conditions were similar to the one used in Example 7. The evolution of cell potential, shown in FIG. 21, is similar to the one obtained in Example 8.2, confirming the possibility to reuse the same LFP anode after an aqueous relithiation step.

### Example 11: Relithiation of a LTO Anode in Aqueous Solution

This example shows the relithiation of an LTO (Li₄Ti₅O₁₂) electrode in aqueous solution. We confirmed complete relithiation.

A LTO based anode made of a thin layer of LTO coated on an Al—C foil was electrochemically relithiated in an aqueous electrolyte. The electrolyte consisted of an aqueous solution of 25M LiFSI with 25% v/v dimethoxy ethane adjusted to a pH of 8 with 2M LiOH. The working electrode was made by sticking a piece of LTO coated foil of about 4 cm² on a glass tile with a double face Al foil. A square mask of PVDF tape was applied to cover the WE's edges leaving an active area of 3.5 cm² exposed to the electrolyte solution. The counter electrode consisted of platinum mesh of about 4 cm². A current of 4 mA/cm² was applied between the cathode and the anode for 60 min while the potential of the working electrode was monitored with a Pt wire pseudo reference electrode. The evolution of working electrode potential is shown in FIG. 22.

Once relithiated, the working electrode was rinsed with ethanol and let to dry for few minutes at 60° C. The relithiation was proven to be completed by performing an anodic linear scan voltammetry in the same electrolyte and using the same experimental set-up. In this respect, the potential of the working electrode was scanned from 0 V vs 0 CV to 1.2 V vs the reference electrode at a scan rate of 0.1 V/s. The resulting voltammogram, shown in FIG. 23, exhibits a large oxidation peak centered at −0.357 V vs Pt corresponding to the oxidation of Li₇Ti₅O₁₂ to Li₄Ti₅O₁₂.

### Example 12: Additives for Electrodeposition of Thin Li

Additive can be added to the electrolyte to improve the aspect and properties of the thin Li film. In this perspective, we tested various additives that can improve the properties of the Li. We confirmed that the use of these additives facilitates Li electrodeposition.

The experiments consisted of Li electrodeposition in coin cells using a 4.5 μm thick copper foil of 16 mm diameter as cathode covered with a 50 μm thick polypropylene mask with an internal diameter of 8 mm. Such mask allowed to create a gap between the cathode and the membrane, by distancing both electrodes, simulating the deposition in a membrane less electrochemical cell. The anode consisted of a LFP film coated on an Al foil as per Example 7. The deposition was performed at a current density of 4 mA/cm² for 10 min.

A series of additives were added to a basic electrolyte composed of a 50/50 EC and DEC with LiCF₃COO and LiFSI electrolytic salts at a concentration of 0.6 M and 0.4 M respectively. As it can be seen in FIG. 24, the initial nucleation phase potential peak was decreased after the addition of 0.2M VC, 0.01M LiDFOB or 0.1M CsPF₆₋. This will result in a more uniform surface coverage of the Cu substrate during the Li electrodeposition.

### Example 13: Synthesis of n-Butyl Li from an Electrodeposited Li

The Li obtained from electrodeposition was successfully used to synthesis n-butyllithium, a commonly used organo-metallic.

To do so, a first electrodeposition was performed in coin cell at a current density of 0.5 mA/cm² for a total charge of 1.44 mAh/cm² on a 4.5 μm thick copper substrate. After the electrodeposition, the 16 mm diameter obtained Li electrode was retrieved from the coin cell in an Ar filled glove box, cleaned from electrolyte residue with THE followed by DEC, and vacuum dried at 25° C. overnight in a dry room.

In order to evaluate the efficiency of the n-butyllithium formation, a titration curve was developed to accurately determine the concentration of n-butyllithium in n-hexane. Consequently, diluted n-butyllithium solutions were prepared at four different concentrations (0.005 M/L, 0.01 M/L, 0.015 M/L, and 0.025 M/L) using a 1.6 M/L commercially available solution. A volume of 25 μL of a saturated solution of n-phenanthroline in a blend of n-hexane and toluene was added to 2 mL of previously prepared n-butyllithium solution. A 2% v/v diluted solution of 2-propanol in n-hexane served as titrant and was added drop by drop up to the bright yellow end-point. The volumetric concentration of titrant solution to sample solution was plotted against the calculated concentration of each diluted solutions of n-butyllithium, resulting with a straight line with a R2 of 99.99% as shown in FIG. 25.

A 2% v/v diluted solution of n-butyl-chloride was prepared in dried n-hexane to synthesize the n-butyllithium from the electrodeposited Li. A 14 mm diameter sub-sample was cut down from the dried Li electrode and put in a vial. The loading of the Li deposit was measured to 0.78 mg. A magnetic stirrer was added to the vial containing 0.435 ml of diluted solution of butyl-chloride. The vial was sealed and agitated for 15 min after which the solution was transferred to a 10 ml volumetric jar. The set-up was rinsed 3 times with n-hexane and transferred to the volumetric jar to recover any trace of n-butyllithium from the vial and the solid residue. Once filled to the gauge with n-hexane, a 5 ml sample was taken from the volumetric jar for titration of the n-butyllithium with 2-propanol. In this respect, a 20 μl of the saturated solution of n-phenanthroline was added to the 5 ml. The dark red color obtained indicated the presence of n-butyllithium. The propanol solution was added drop by drop up to the bright yellow end-point (0.070 ml in this case). From the titration, it was determined that 0.42 mg of Li reacted with the butyl-chloride corresponding to a reaction efficiency of 67%.

### Example 14: Pre-Lithiation of a Li Intercalation Anode

The following example serves to demonstrate the application of the present method for pre-lithiating anodic compounds in order to reduce their Li loss during formation cycles. Hence, the capacity loss of a graphite containing anode and a SiO containing anode was significantly reduced after pre-lithiation.

In a first example, a commercially available graphite electrode sheet made of a Li intercalation layer containing 95% w/w of synthetic graphite coated on an 8 μm thick copper foil was used. The active loading was 6.7 mg/cm² for a specific capacity of 2.27 mAh/cm². Disc electrodes of 16 mm diameter were punched in the graphite electrode and mounted in coin cells against an LFP electrode (the same composition as in Example 12) separated by a Celgard™ membrane and filled with the same basic electrolyte as in Example 12. Then, the graphite electrodes were submitted to galvanostatic charge at 0.5 mA/cm² for 0.36 mAh/cm² or 0.48 mAh/cm² corresponding to 16% and 21% respectively of the graphite anode capacity. The galvanostatic curves are shown in FIG. 26.

Similarly, a commercially available silicone oxide (SiOx) electrode sheet made of a Li intercalation layer composed of 81% w/w of SiOx, 4% w/w of carbon nano-tube, and 15% w/w of polyimide having a specific capacity of 2.52 mAh/cm2. The SiOx electrodes were submitted to galvanostatic charge at 0.5 mA/cm2 for 0.75 mAh/cm2 or 1.0 mAh/cm2 corresponding to 30% and 40% respectively of the SiOx anode capacity. The galvanostatic curves are shown in FIG. 27.

The initial Li loss of each pre-lithiated anode was compared to their corresponding pristine sample through electrochemical cycling against LFP under potential limited galvanostatic charge and discharge protocol starting with first formation cycle at C/24 followed by two other formation cycles at C/10 and a cycling stability protocol at C/3 and 1C for charge and discharge respectively. The potential was limited between 2V vs Li and 4 V vs Li for graphite anodes and 2V vs Li and 3.8 V vs Li for SiOx anodes. FIG. 28 compares the cycling reversibility of the first formation cycle of pristine and pre-lithiated graphitic anodes. While a capacity loss of 21% is observed for the pristine graphitic anode, the 15% pre-lithiated anode shows only a 3% capacity loss and a full reversibility for the 20% pre-lithiated anode. In a similar way, SiOx pre-lithiation improves the capacity loss from 68% for pristine material to only 32% for the 30% pre-lithiated anode and 11% for the 40% pre-lithiated anode. FIG. 29 compares the cycling reversibility of the first formation cycle of pristine and pre-lithiated SiOx anodes.

The scope of the claims should not be limited by the preferred embodiments set forth in the examples, but should be given the broadest interpretation consistent with the description as a whole.

### REFERENCES

The present description refers to a number of documents, the content of which is herein incorporated by reference in their entirety. These documents include, but are not limited to, the following:
Lee et al., “Synthesis of Lithium Thin Film by Electrodeposition from Ionic Liquid”, Applied Mechanics and Materials, 217-219, November 2012, pp 1049-1052
Porthault et al., “Electrodeposition of lithium metal thin films and its application in all-solid-state micro batteries”, Electrochimica Acta 194 (2016) 330-337
Coyle et al., Recycle of End-of-Life NMC 111 Cathodes By Electrochemical Relithiation, 2019 Meet. Abstr. MA2019-02 449
Montoya et al., Relithiation of Cathode Materials for the Recycling of Lithium-Ion Batteries, 2019 Meet. Abstr. MA2019-02 444
Shi et al., Ambient-Pressure Relithiation of Degraded LiₓNi_{0.5}Co_{0.2}Mn_{0.3}O₂ (0<x<1) via Eutectic Solutions for Direct Regeneration of Lithium-Ion Battery Cathodes, Advanced Energy Materials, Volume 9, Issue 20, May 23, 2019, U.S. Pat. No. 1,900,454
Zhou et al., Direct recovery of scrapped LiFePO₄ by a green and low-cost electrochemical re-lithiation method, Green Chem., 2022, 24, 6278-6286
Lahtinen et al., Reuse of LiCoO₂ Electrodes Collected from Spent Li-Ion Batteries after Electrochemical Re-Lithiation of the Electrode, ChemSusChem 2021, 14, 1-12
Zhang et al., Electrochemical Relithiation for Direct Regeneration of LiCoO₂ Materials from Spent Lithium-Ion Battery Electrodes, ACS Sustainable Chem. Eng. 2020, 8, 31, 11596-11605
Holtstiege et al., Pre-Lithiation Strategies for Rechargeable Energy Storage Technologies: Concepts, Promises and Challenges, Batteries 2018, 4(1), 4
WO 2019/113534
WO 2019/070896 A1
WO 2017/095989 A1
WO 2021/092692
US20220328800A1
US20210091426A1
US20210381115A1
US20180040914A1
US20160351889A1
CN112216819B
CN110504451B
EP3358046B1
DE102018207391A1

1-117. (canceled)

118. A production electrolysis cell for producing Li metal or an alloy thereof or for pre-lithiating an electrode material, the production electrolysis cell comprising:
a relithiated Li intercalation material used as a production anode,
a current collector or said electrode material used as a production cathode, and
a production electrolyte between the production cathode and the production anode, wherein the production electrolyte comprises a production lithium salt dissolved in a production solvent.

119. The production electrolysis cell of claim 118, wherein the relithiated Li intercalation material is a lithium phosphate or a lithium oxide.

120. The production electrolysis cell of claim 118, wherein the relithiated Li intercalation material has been sourced from spent electrodes and then relithiated; or wherein the relithiated Li intercalation material has been used for producing Li metal or an alloy thereof or for pre-lithiating an electrode material and then relithiated.

121. The production electrolysis cell of claim 118, being for a Li production electrolysis reaction, wherein the production anode further comprises a current collector and the relithiated Li intercalation material is deposited on the current collector, and wherein the current collector is a metal sheet, or is made of a conductive carbon material, or is a polymer-based current collector.

122. The production electrolysis cell of claim 118, being for producing Li metal or an alloy thereof, wherein the current collector is used as the production cathode, and wherein the current collector used as the production cathode is made of Cu, Al, protected Al, C, stainless steel, Ti, Zn, or Ni, or any alloy thereof, or is a polymer-based metalized current collector, or a combination thereof.

123. The production electrolysis cell of claim 118, being for producing Li metal or an alloy thereof, wherein the current collector is used as the production cathode, and wherein current collector is protected by a protection layer.

124. The production electrolysis cell of claim 118, being for producing Li metal or an alloy thereof, wherein the current collector is used as the production cathode, and wherein the surface of the current collector used as the production cathode is treated or modified to improve its lithiophilicity.

125. The production electrolysis cell of claim 118, being for producing Li metal or an alloy thereof, wherein the current collector is used as the production cathode, and wherein the surface of the current collector used as the production cathode is treated or modified to have a 3D structure to improve the electrochemical performance of the Li layer in batteries or to increase its reaction rate.

126. The production electrolysis cell of claim 118, being for pre-lithiating an electrode material, and wherein the electrode material is used as the production cathode.

127. The production electrolysis cell of claim 118, wherein the production electrolysis cell is free of a membrane separating the production anode from the production cathode.

128. The production electrolysis cell of claim 127, wherein the production electrolysis cell is in a roll-to-roll configuration.

129. The production electrolysis cell of claim 128, wherein the production electrolysis cell further comprises one or more calendering devices.

130. A method for producing Li metal or an alloy thereof or for pre-lithiating an electrode material, the method comprising:
a) providing a relithiated Li intercalation material, and
b) carrying out a Li production electrolysis reaction in a production electrolysis cell,
wherein the production electrolysis cell is a production electrolysis cell according to claim 118,
thereby electrodepositing Li metal or the alloy thereof on the current collector used as the production cathode or introducing lithium in said electrode material used as the production cathode thus producing a pre-lithiated electrode, and
thereby producing a partially or completely de-lithiated Li intercalation material.

131. The method of claim 130, wherein step a) and/or step b) is carried out in a roll-to-roll configuration.

132. The method of claim 130, wherein step a) comprises:
a′) providing a partially or completely de-lithiated Li intercalation material and
a″) relithiating the partially or completely de-lithiated Li intercalation material, thereby producing a relithiated Li intercalation material.

133. The method of claim 132, further comprising step c) of repeating step a) and step b) one or more times, using in steps a′) and a″) the partially or completely de-lithiated Li intercalation material produced in step b.

134. The method of claim 132, wherein step a″) comprises carrying out a relithiation electrolysis reaction in a relithiation electrolysis cell, wherein the relithiation electrolysis cell comprises:
the partially or completely de-lithiated intercalation material as a relithiation cathode,
a relithiation anode, and
a relithiation electrolyte between the relithiation cathode and the relithiation anode, wherein the relithiation electrolyte comprises a relithiation lithium salt dissolved in a relithiation solvent,
thereby relithiating the partially or completely de-lithiated intercalation material and producing the relithiated Li intercalation material.

135. The method of claim 134, wherein the relithiation electrolyte further comprises one or more additives.

136. The method of claim 134, further comprising the step of producing the relithiation salt in the relithiation electrolysis cell by adding a lithium precursor and a reactant to the relithiation electrolysis cell and allowing the lithium precursor and the reactant to react to form the relithiation salt.

137. The method of claim 136, wherein the lithium precursor and the reactant are added to a salt formation compartment of the relithiation electrolysis cell that is in fluid communication with a main compartment of the relithiation electrolysis cell; the main compartment comprising the relithiation cathode and the relithiation anode.

138. The method of claim 132, wherein step a″) comprises (i) adding the partially or completely de-lithiated intercalation material to a solution containing a reducing agent and a relithiation salt in a solvent; thereby relithiating the partially or completely de-lithiated intercalation material and producing the relithiated Li intercalation material.

139. The method of claim 138, further comprising (ii) separating the relithiated Li intercalation material from the solution; and (iii) electrochemically treating the solution separated in step (ii) to regenerate the reducing agent.

140. The method of claim 130, further comprising using the current collector with the Li metal or the alloy thereof or the pre-lithiated electrode as a negative electrode in a primary or secondary Li battery, as a source of Li metal or an alloy for the prelithiation of electrode material, or as a source of lithium for the manufacture of an energy storage system.

141. The method of claim 130, further comprising using the current collector with the Li metal or the alloy thereof as a source of Li metal or an alloy thereof for the preparation of an organolithium compound.

142. The method of claim 130, being for pre-lithiating an electrode material, and wherein the electrode material is used as the production cathode.
